(19) United States
(12) Patent Application Publication
(10) Pub. No.: US 2023/0259768 A1
(43) Pub. Date: Aug. 17, 2023

(54) Machine-Learned Spectrum Analysis

(71) Applicant: Battelle Energy Alliance, LLC, Idaho Falls, ID (US)

(72) Inventors: Ryan G. Fronk, Idaho Falls, ID (US); Matthew W. Anderson, Idaho Falls, ID (US); Michael A. Reichenberger, Idaho Falls, ID (US); Dawn M. Scates, Idaho Falls, ID (US); Edward L. Reber, Idaho Falls, ID (US)

(73) Assignee: Battelle Energy Alliance, LLC, Idaho Falls, ID (US)

(21) Appl. No.: 18/164,145

(22) Filed: Feb. 3, 2023

Related U.S. Application Data
(63) Continuation of application No. PCT/US21/10034, filed on Aug. 13, 2021.

(51) Int. Cl. G06N 3/08; G06N 5/022

(52) U.S. Cl. CPC G06N 3/08; G06N 5/022

(57) ABSTRACT

The present disclosure describes aspects of a machine-learned (ML) spectrum analysis configured to distinguish between a plurality of radioisotope types and/or a plurality of emission levels of respective radioisotope types within spectrum data. The ML spectrum analyzer may utilize an artificial neural network (ANN) having an output layer configured to produce prediction data for respective labels, each label corresponding to a respective radioisotope. The prediction data may be configured to quantify an amount of each respective radioisotope within a subject of the spectrum.

### CROSS-REFERENCE TO RELATED APPLICATIONS

This application claims priority to PCT Application No. PCT/US21/10034, filed Aug. 13, 2021, which is hereby incorporated by reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### BACKGROUND

Unless otherwise indicated herein, the approaches described in this section are not prior art to the claims in this disclosure and are not admitted to be prior art by inclusion in this section.

Spectrum analysis techniques involve numerical analysis, which can introduce uncertainty into the analysis results. For instance, radioisotopes can be identified by detecting characteristic peaks within radiation spectra. The characteristic peaks are often identified and measured using numerical techniques, such as peak or curve fitting, e.g., fitting data points of spectra to a mathematical model, such as a polynomial, cubic spline, Gaussian model, or the like. The use of these types of numerical techniques can have significant disadvantages. For example, numerical curve fitting can become unreliable when applied to spectra data having relatively high, or relatively low data rates (e.g., high or low count rates), background noise, multiple peaks, overlapping peaks, and/or the like. Moreover, these techniques can be sensitive to changes resulting from geometry changes (e.g., jitter or other perturbations with respect to position of a detector relative to the target), environmental changes, and so on. As such, accurate spectral analysis may require expert human interaction, which can be time consuming, expensive, and prone to human error and/or bias.

### BRIEF DESCRIPTION OF THE DRAWINGS

Examples of systems, methods, devices, and computer-readable storage media comprising instructions configured to implement aspects of machine learning or machine learned (ML) spectrum analysis are set forth in the accompanying figures and detailed description:

FIG. 1 illustrates an example operating environment including an apparatus that can implement aspects of machine-learned spectrum analysis, as disclosed herein.

FIG. 2A illustrates an example of an optical spectrum configured for analysis by a ML module, as disclosed herein.

FIG. 2B illustrates an example of an emission spectrum configured for analysis by a ML module, as disclosed herein.

FIG. 2C illustrates an example of a gamma spectrum configured for analysis by a ML module, as disclosed herein.

FIG. 3A illustrates a section of another example of a gamma spectrum.

FIG. 3B illustrates an example of an automated curve fit operation.

FIG. 3C illustrates and example of an interactive curve fit operation.

FIG. 4A illustrates an example apparatus configured to implement aspects of ML spectrum analysis.

FIG. 4B illustrates another example of an apparatus configured to implement aspects of ML spectrum analysis.

FIG. 5A illustrates another example of an apparatus that can implement machine-learned spectrum analysis in accordance with aspects of the disclosure.

FIG. 5B illustrates an example of an artificial neural network for machine-learned spectrum analysis in accordance with aspects of the disclosure;

FIG. 5C illustrates an example of an apparatus configured to implement machine-learned spectrum analysis in accordance with aspects of the disclosure;

FIG. 6A illustrates further examples of apparatus that can implement machine-learned spectrum analysis in accordance with aspects of the disclosure;

FIG. 6B illustrates further examples of apparatus configured to implement machine-learned spectrum analysis in accordance with aspects of the disclosure;

FIG. 7A illustrates another example of a ML model configured to implement aspects of spectrum analysis;

FIG. 7B illustrates another example of a training dataset;

FIG. 8 illustrates a flow diagram of an example method for implementation of ML spectrum analysis by an apparatus;

FIG. 9A is a flow diagram illustrating an example of a method for determining training bias weights;

FIG. 9B is a flow diagram illustrating an example of a method for determining an uncertainty of predictions determined for a spectrum;

FIG. 10 illustrates a flow diagram of another example method for implementation of ML spectrum analysis by an apparatus;

FIG. 11 illustrates a flow diagram of another example method for implementation of ML spectrum analysis by an apparatus; and

FIG. 12 illustrates a flow diagram of further examples of methods for implementing ML spectrum analysis.

### DETAILED DESCRIPTION

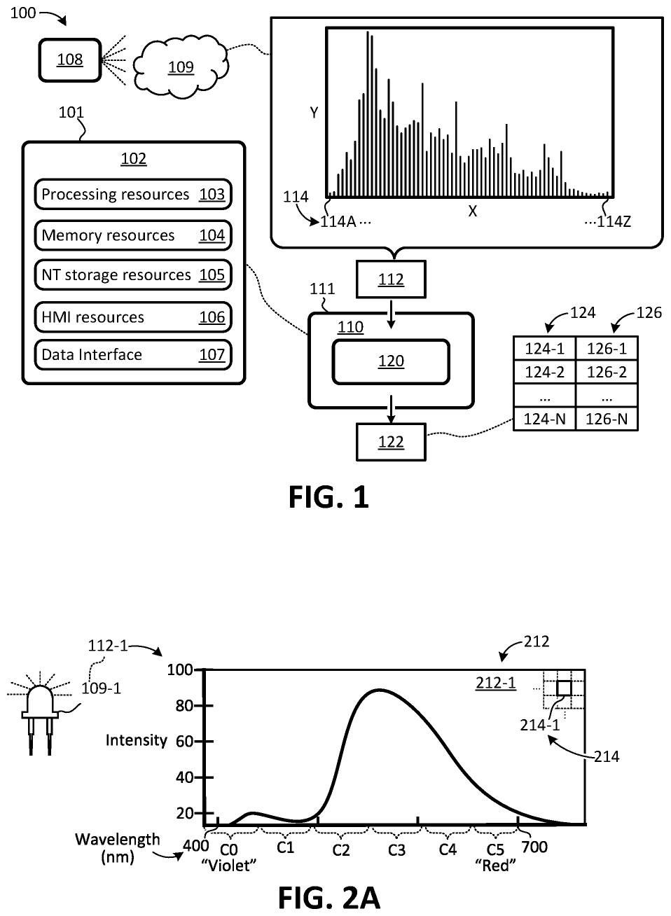

FIG. 1 illustrates an example of a system 100 comprising a device and/or apparatus 101 configured to implement aspects of ML spectrum analysis, as disclosed in further detail herein. The apparatus 101 may comprise and/or be embodied by one or more physical components, which may include, but are not limited to: an electronic device, a computing device, a general-purpose computing device, an application-specific computing device, a mobile computing device, a smart phone, a tablet, a laptop, a server device, a distributed computing system, a cloud-based computing system, an embedded computing system, a programmable logic device, a field programmable gate array (FPGA), an application-specific integrated circuit (ASIC), and/or the like.

As illustrated in FIG. 1, the apparatus 101 may comprise and/or be coupled to computing resources 102, which may include, but are not limited to: processing resources 103 (e.g., a processor), memory resources 104, non-transitory (NT) storage resources 105, and human-machine interface (HMI) resources 106. The processing resources 103 may comprise any suitable processing means including, but not limited to: a processor, a processing unit, a physical processor, a virtual processor (e.g., a virtual machine), an arithmetic-logic unit (ALU), a central processing unit (CPU), a general-purpose processor, an ASIC, programmable logic, an FPGA, a System on Chip (SoC), virtual processing resources, or the like. The memory resources 104 may comprise any suitable memory means including, but not limited to: volatile memory, non-volatile memory, random access memory (RAM), dynamic RAM (DRAM), synchronous DRAM (SDRAM), cache memory, or the like. The NT storage resources 105 may comprise any suitable non-transitory, persistent, and/or non-volatile storage means including, but not limited to: a non-transitory storage device, a persistent storage device, an internal storage device, an external storage device, a remote storage device, Network Attached Storage (NAS) resources, a magnetic disk drive, a hard disk drive (HDD), a solid-state storage device (SSD), a Flash memory device, and/or the like. The HMI resources 106 may comprise any suitable means for human-machine interaction including, but not limited to: input devices, output devices, input/output (I/O) devices, visual output devices, display devices, monitors, touch screens, a keyboard, gesture input devices, a mouse, a haptic feedback device, an audio output device, a neural interface device, and/or the like.

The apparatus 101 may comprise machine learning or machine learned (ML) module 110. The ML module 110 be implemented and/or embodied by computing resources 102 of the apparatus 101. For example, the ML module 110 may be configured for operation on processing resources 103 of the apparatus 101, utilize memory resources 104 of the apparatus 101, be embodied by computer-readable instructions stored within NT storage resources 105 of the apparatus 101, and so on. Alternatively, or in addition, aspects of the ML module 110 may be implemented and/or realized by hardware components, such as application-specific processing hardware, an ASIC, FPGA, dedicated memory resources, and/or the like. In some implementations, the ML module 110 includes a processor, ML processing platform, an ML processing environment, an ML processing toolkit, an ML processing library and/or the like.

As disclosed in further detail herein, the ML module 110 may be configured to implement aspects of practical spectral analysis applications, which may include, but are not limited to: element analysis, radioisotope analysis, imaging (e.g., X-ray imaging), diffraction analysis (e.g., X-ray diffraction), neutron activation analysis (NAA), gas chromatography, optical spectral analysis, and/or the like. Implementation of a spectral analysis application may comprise configuring an ML module 120 to process spectra 112 (and/or spectrum data 112) pertaining to the spectral analysis application. More specifically, the ML module 120 may be configured to generate spectrum analysis data 122 in response to respective spectra 112. As used herein, spectral input data 112 (or a spectrum 112) refers to data that corresponds to and/or can vary across a continuum, such as a range of frequencies, energies, wavelengths, or the like. A spectrum 112 may comprise continuous data, e.g., may comprise and/or be modeled as a function ƒ(x) defined over the range covered by the spectrum 112. Alternatively, a spectrum 112 may comprise discrete values mapped to respective locations or regions of the spectrum 112, such as respective channels. As used herein, a “spectrum channel” or “channel” may refer to a specified location, position, offset, region, or range within a spectrum 112. For example, a spectrum 112 may comprise channels corresponding to respective frequencies (or frequency ranges), respective energy levels (or energy ranges), respective wavelengths (or wavelength ranges), or the like.

The spectra 112 analyzed by the ML module 110 may be associated with respective targets or subjects 109. As used herein, a “target” or “subject” 109 may refer to any potential source or subject of spectral analysis (e.g., a potential source of spectral data), including, but not limited to an object, an item, a target, a container, an area, a region, a volume, a substance, a material, a vehicle, a person, an experiment, or any other potential source of passive or actively acquired spectra 112.

In some implementations, the ML module 110 may be configured to analyze spectra 112 captured by an acquisition device 108. The acquisition device 108 may comprise any suitable means for acquiring spectral data (e.g., spectra 112) including, but not limited to a spectrometer, an optical spectrometer, a radiation spectrometer, a gamma ray spectrometer, an x-ray spectrometer, a neutron spectrometer, a gas chromatography spectrometer, a mass spectrometer, and/or the like. The ML module 110 may receive input spectra 112 through a data interface 107. The data interface 107 may comprise any suitable data communication and/or interface means including, but not limited to: a communication interface, an I/O interface, a network interface, an interconnect, and/or the like. The data interface 107 may be configured to couple the apparatus 101 to one or more external devices and/or components. In some implementations, the data interface 107 is configured to couple the apparatus 101 to one or more electronic communication networks, such as a wired network, a wireless network, a local area network (LAN), a wide area network (WAN), a virtual private network (VPN), Internet Protocol (IP) networks, Transmission Control Protocol/Internet Protocol (TCP/IP) networks, the Internet, or the like. Alternatively, or in addition, the data interface 107 may be configured to couple the ML module 110 to one or more data sources, such as a data repository, acquisition device 108, or the like.

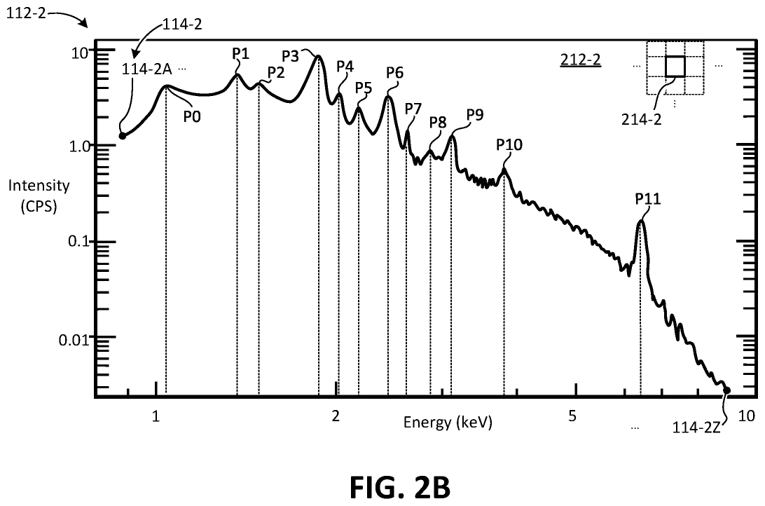

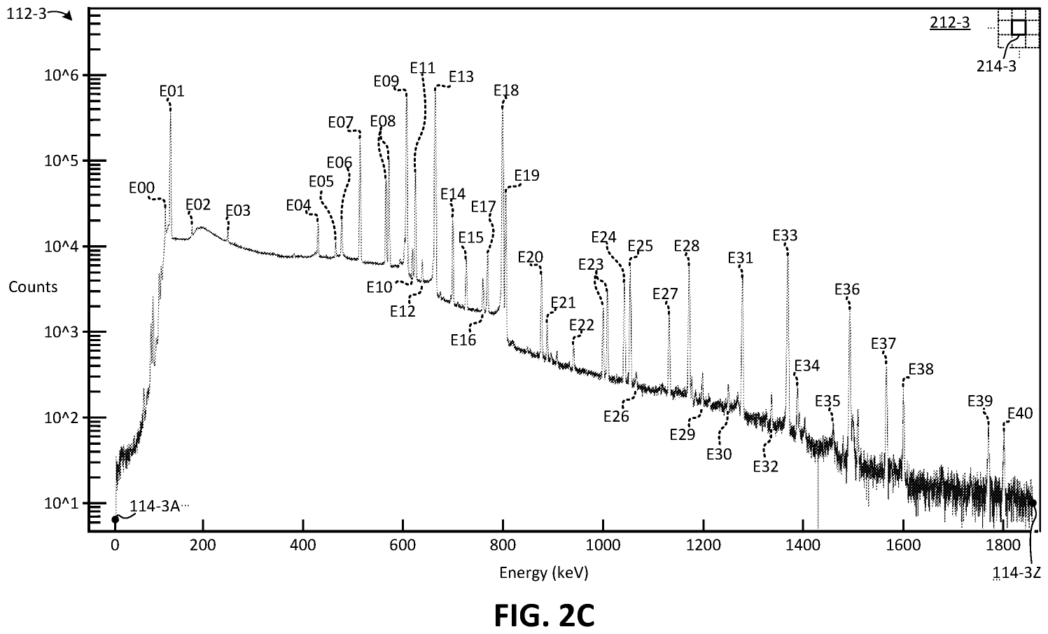

The ML module 110 may be configured to analyze optical spectra 112, such as the spectrum 112-1 illustrated in FIG. 2A, the spectrum 112-1 may correspond to optical radiation produced by a subject 109-1, such as a “warm” light emitting diode (LED). The spectrum 112-1 may be configured to cover human-visible wavelengths from about 380 nanometers (nm) to about 700 nm. The spectrum 112-1 may be organized into channels of any suitable type or size. In the FIG. 2A example, the spectrum 112-1 comprises channels C0 through C5 corresponding to respective human-visible colors, including channel C0 corresponding to “violet,” channel C1 corresponding to “blue/indigo,” channel C2 corresponding to “green/blue,” channel C3 corresponding to “yellow,” channel C4 corresponding to “orange,” channel C5 corresponding to “red,” and so on.

Referring back to FIG. 1, the ML module 120 may be configured to implement practical applications of spectrum analysis, such as neutron spectroscopy, x-ray spectroscopy, gamma-ray spectroscopy, and/or the like (e.g., may be configured to analyze neutron, x-ray, and/or gamma-ray spectra 112). The ML module 120 may be configured to generate analysis data 122 in response to respective spectra 112. As disclosed in further detail herein, the analysis data 122 generated for a spectrum 112 may be based, at least in part, on features 114 of the spectra 112. As used herein, a “feature” 114 or “spectrum analysis feature” 114 may refer to any input variable suitable for analysis by the ML module 120. The ML module 120 may be configured to extract and/or analyze features 114 of any suitable type, including, but not limited to: data values corresponding to respective locations within a spectrum 112 (e.g., data values mapped to respective spectrum locations or regions, such as respective frequencies, energies, wavelengths, or the like), data values corresponding to respective spectrum channels, data values corresponding to a representation the spectrum 112, such as pixels of an image representation of the spectrum 112, and/or the like. By way of non-limiting example, the ML module 120 may be trained to analyze features 114 of optical spectra 112, such as the spectrum 112-1 illustrated in FIG. 2A; in these examples, the features 114 analyzed by the ML module 120 may comprise intensity values mapped to respective wavelengths (intensity values for wavelengths ranging from about 380 nm to about 700 nm), intensity values corresponding to respective channels (e.g., channels C0 through C5), pixels 214-1 of an image representation 212-1 of the spectrum 112-1, and/or the like.

Alternatively, or in addition, the ML module 120 may be configured to analyze features of other types of spectra 112, such as radiation spectra (e.g., emission spectra, x-ray spectra, nuclear decay spectra, gamma spectra, and/or the like). In these embodiments, the ML module 120 may be configured to analyze radiation spectra features 114, which may include, but are not limited to: data values corresponding to respective radiation energies (e.g., features 114A through 114Z, each corresponding to a respective one of Z energy levels), data values corresponding to respective channels, each channel corresponding to a respective radiation energy level or range (e.g., features 114A through 114Z, each corresponding to a respective one of Z channels), image pixels corresponding to an image representation of the radiation spectrum 112, and/or the like. For example, the features 114A-Z of the spectrum 112 illustrated in FIG. 1 may represent respective radiation energies. For example, features 114A through 114Z may comprise “counts” at respective energies (or channels); each count indicating a number, quantity, amount, or other measure of radiation of a specified energy detected over a specified period (Td) or a normalized detection period, e.g., counts per second (CPS) or the like.

In some embodiments, the ML module 110 may be configured for emission spectrum analysis. Elements may emit radiation at characteristic energies, which may be represented as peaks or emission lines within emission spectra 112. The peaks within the emission spectrum 112 of a subject 109 may, therefore, indicate which elements are present within the subject 109 and the intensity of the peaks may correspond to the quantity or concentration of the elements within the subject 109. FIG. 2B illustrates an example of an emission spectrum 112-2. The emission spectrum 112-2 may correspond to emissions detected from an astronomical object, such as a star, nebula, remnant of a supernova, or the like. The ML module 120 may be configured to extract and/or analyze spectral features 114-2, such as “counts” or other measures of radiation intensity at respective energies 114-2A through 114-2Z (and/or at respective energy ranges or channels), pixels 214-2 of an image representation 212-2 of the spectrum 112-2, or the like. In the FIG. 2B example, radiation energy is represented in terms of kiloelectron volts (keV) and intensity is expressed in terms of CPS. As illustrated in FIG. 2B, the emission spectrum 112-2 may comprise peaks at characteristic energies; peak P0 may be characteristic of Neon (Ne), P1-P2 may be characteristic of Magnesium (Mg), P3-P5 may be characteristic of Silicon (Si), P6-P8 may be characteristic of Sulfur (S), P9 may be characteristic of Argon (Ar), P10 may be characteristic of Calcium (Ca), and P11 may be characteristic of Iron (Fe).

Referring back to FIG. 1, the ML module 120 may be configured to predict labels 124 for respective spectra 112. As used herein, a label 124 may refer to any suitable subject of spectrum analysis including, but not limited to: a class, a classification, a category, a tag, a name, a label, or the like. The ML module 120 may be adapted to predict labels 124 that represent and/or correspond to spectrum characteristics, such as respective spectrum locations, offsets, positions, regions, ranges, or the like. The spectrum characteristics of the labels 124 may correspond to the spectrum analysis application the ML module 120 is configured to implement. For example, in emission spectrum analysis embodiments, the ML module 120 may be configured to predict labels 124 corresponding to characteristic energies of respective elements (e.g., labels 124 corresponding to characteristic emission energies of Ne, Mg, Si, S, Ar, Ca, Fe, and so on). In another example, the ML module 120 may be configured to implement aspects of radioisotope analysis; in these embodiments, the ML module 120 may be configured to predict labels 124 corresponding to radiation energies characteristic of respective radioisotopes of interest (e.g., energies at which the respective radioisotopes emit radiation during nuclear decay).

The spectrum analysis data 122 produced by the ML module 120 may include predictions 126 for respective labels 124. As used herein, a “prediction” 126 or “prediction data” 126 may refer to any suitable information pertaining to analysis of a spectrum 112 with respect to a label 124, including, but not limited to: data indicating the presence (or absence) of the label 124 in the spectrum 112, data indicating a probability that the particular label 124 is present in the spectrum 112, data indicating the presence (or absence) of a specified activity level of the label 124 in the spectrum 112, data indicating a probability of a specified activity level of the label 124 within the spectrum 112, data quantifying an activity of the label 124 within the spectrum 112 (e.g., a concentration, intensity, emission level, or quantity of the label 124), data indicating an estimated accuracy (or uncertainty) of the prediction 126 determined for the label 124, a probability value, and/or the like.

In some implementations, the spectrum analysis data 122 produced by the ML module 120 for respective spectra 112 may be configured to quantify the “activity” of respective labels 124 within respective spectra 112. As used herein, the “activity” or “spectral activity” of a label 124 within a spectrum 112 may refer to an amount, intensity, concentration, quantity, emission level, or other measure of activity. For instance, in a first non-limiting example, the ML module 120 may be configured for emission spectrum analysis and, in particular, to predict labels 124 configured to represent respective elements (e.g., labels 124 corresponding to radiation energies characteristic of the respective elements), including a label 124-1 corresponding to 3.10 keV, which may be characteristic of Argon (Ar). The prediction data 126-1 determined for the label 124-1 in response to an emission spectrum 112 may comprise an activity quantity configured to quantify emission radiation at 3.10 keV within the spectrum 112 (quantify an amount of radiation energy at 3.10 keV within the spectrum 112). The prediction data 126-1 may, therefore, comprise a prediction of the quantity or concentration of Argon (Ar) within the subject 109 of the emission spectrum 112. In a second non-limiting example, the ML module 120 may be configured for radioisotope analysis and, as such, may predict labels 124 corresponding to energies characteristic of respective radioisotopes of interest, including a label 124-1 corresponding to 123.07 keV, which may be characteristic of Europium-154 (Eu-154). The prediction data 126-1 determined for the label 124-1 may comprise an activity quantity configured to quantify radiation emission activity at 123.07 keV within respective spectra 112. The prediction data 126 (and/or activity quantities thereof) may be configured to quantify emission activity or level in any suitable means, including, but not limited to: count, CPS, emission, emission level, Curie (Ci) (a unit of radioactivity equal to 3.7×10¹⁰ disintegrations per second), microcurie (μCi), and/or the like. Since spectral activity at the characteristic energy level(s) of a radioisotope may be proportional to the quantity of the radioisotope, the prediction data 126-1 determined for a spectrum 112 may comprise a prediction of the quantity of Eu-154 within the subject 109 of the spectrum 112. Although particular examples of labels 124 and prediction data 126 are described herein, the disclosure is not limited in this regard. The ML module 120 could be adapted to analyze any suitable type of spectra 112 (e.g., emission spectra 112, radiation spectra, x-ray spectra 112, gamma spectra 112, and/or the like). Moreover, the ML module 120 may be configured to generate prediction data 126 pertaining to labels 124 corresponding to any suitable aspect or subject of spectral analysis.

As disclosed herein, in some embodiments the ML module 120 may be configured to implement aspects of emission spectra analysis, which may comprise predicting the concentration and/or quantity of specified elements of interest within subjects 109 based on emission spectra 112 of the subjects 109. For example, the ML module 120 may be trained to predict labels 124-1 through 124-N, each label 124 configured to represent an energy characteristic of a respective element of interest (e.g., labels 124 corresponding to characteristic emission energies of Ne, Mg, Si, S, Ar, Ca, and Fe, respectively). The prediction data 126-1 through 126-N determined by the ML module 120 in response to an emission spectrum 112 of a subject 109 may, therefore, quantify activity at the characteristic energies represented by the labels 124-1 through 124-N, which may be proportional to the amount or concentration of the corresponding elements within the subject 109.

Alternatively, or in addition, the ML module 120 may be configured for radioisotope analysis. As used herein, a “radioisotope” may refer to an isotope, a radioactive isotope, a radioactive nuclide, a radionuclide, or other material that is subject to nuclear decay, such as alpha decay, beta decay, gamma decay, or the like. Alpha decay is a nuclear decay process in which an unstable nucleus of a radioisotope (e.g., a radionuclide) changes to another element, resulting in emission of an alpha (a) particle (e.g., a helium nucleus comprising two protons and two neutrons). In beta decay, a nucleon of an unstable nucleus of the radioisotope is transformed into a different type, resulting in emission of a beta (β) particle or β-ray (e.g., an electron in beta minus decay and neutrino in beta plus decay). In gamma decay, high-energy gamma radiation (γ-rays) are released as subatomic particles of the radioisotope (e.g., protons and/or neutrons) transition from high-energy states to lower-energy states.

Radioisotopes may be associated with characteristic radiation (or characteristic radiation energies). In other words, the radiation emitted by a radioisotope during nuclear decay may be distinguishable from radiation produced by other sources, such as other elements, other types of radioisotopes, background radiation, and/or the like. The ML module 120 may be configured to detect, identify, and/or quantify the radioisotopes within respective subjects 109 (if any) based on radiation spectra 112 of the subjects 109.

In some embodiments, the ML module 120 may be configured to analyze spectra 112 within the gamma nuclear range (gamma spectra 112). As used herein, “gamma spectral data” or “gamma spectra” 112 refers to spectra 112 spanning gamma radiation energies, e.g., radiation energies ranging from 20 megaelectron volts (MeV), or higher, down to 1 keV, or lower. Gamma spectra 112 may be acquired by any suitable detection means and/or any suitable acquisition device 108 including, but not limited to: a radiation detector, a radiation spectrometer, a gamma-ray detector, a gamma-ray counter, a gamma-ray spectrometer (GRS), a scintillation (SCT) detector, a SCT counter, a Sodium Iodide SCT detector, a Thallium-doped Sodium Iodide (NaI(Tl)) SCT detector, a lithium-doped Germanium (Ge(Li)) SCT detector, a semiconductor-based (SCD) detector, a Germanium SCD detector, a Cadmium Telluride SCD detector, a Cadmium Zinc Telluride SCD detector, or the like. In SCT-based devices, the energy of detected gamma photons may be determined based on the intensity of corresponding flashes produced within a scintillator or scintillation counter (e.g., based on the number of low-energy photons produced by respective high-energy gamma photons). In SCD-based devices, the energy of detected gamma photons may be determined based on the magnitude of electrical signals produced by the gamma photons (e.g., the magnitude of corresponding voltage or current signals).

FIG. 2C illustrates an example of a gamma spectrum 112-3. The gamma spectrum 112-3 may comprise features 114-3 quantifying radiation at energies ranging from out 0 keV (feature 114-3A) up to about 18.5 MeV (feature 114-3Z). The features 114-3 may correspond to respective channels, each channel comprising a count, CPS, or other measure of radiation emission. For example, the ML module 120 may be configured to analyze gamma spectra 112 comprising 8192 channels (or 8192 features 114-3), each of the 8192 channels corresponding to a respective energy level or energy range within the gamma spectrum 112. Alternatively, or in addition, the features 114-3 may comprise and/or correspond to pixels 214-3 of an image representation 212-3 of the spectrum 112-3.

The gamma spectrum 112-3 illustrated in FIG. 2C may be acquired from a subject 109 such as a fusion product, reactor fuel sample, or the like. The spectrum 112-3 may comprise peaks at characteristic energies of respective radioisotopes. In the FIG. 2C example, the spectrum 112-3 comprises peaks at characteristic energies E0 through E40, corresponding to Europium-154 (Eu-154), Cerium-134 (Ce-134), Ce-144, Antimony-125 (Sb-125), Rhodium-106 (Rh-106), Caesium-137 (Cs-137), Praseodymium-144 (Pr-144), Zirconium 95 (Zr-95), Niobium-95 (Nb-95), Silver-110m (Ag-110m), Cobalt-60 (Co-60), and Potassium-40 (K-40), as illustrated in Table 1 below:

TABLE 1

| Radioisotope | Characteristic energy (keV) |
|---|---|
| Eu-154 | 123.07 (E00), 248.0 (E03), 996.3 and 1004.8 (E23), |
| | 1274.54 (E33), 1596.5 (E38) |
| Ce-144 | 133.5 (E01) |
| Sb-125 | 176.3 (E02), 427.9 (E04), 463.4 (E05), 636.0 (E12) |
| Ce-134 | 475.3 (E06), 563.2 and 569.3 (E08), 604.7 (E09), 795.9 |
| | (E18), 801.9 (E19), 1038.6 (E24), 1167.94 (E28), |
| | 1365.1 (E31) |
| Rh-106 | 511.8 (E07), 616.2 (E10), 621.9 (E11), 873.5 (E20), |
| | 1050.4 (E25), 1062.2 (E26), 1128.0 (E27), 1194.7 |
| | (E29), 1265.4 (E30), 1562.2 (E37), 1766.3 (E39), |
| | 1796.8 (E40) |
| Cs-137 | 661.7 (E13) |
| Pr-144 | 696.5 (E14), 1489.1 (E36) |
| Zr-95 | 724.2 (E15), 756.7 (E16) |
| Nb-95 | 765.8 (E17) |
| Ag-110m | 844.7 (E21), 937.5 (E22), 1384.3 (E34) |
| Co-60 | 1332.5 (E32) |
| K-40 | 1460.8 (E35) |

Although particular examples of radioisotopes having particular characteristic energies are described herein, the disclosure is not limited in this regard and could be adapted for detection of any suitable radioisotopes associated with any suitable characteristic radiation energy.

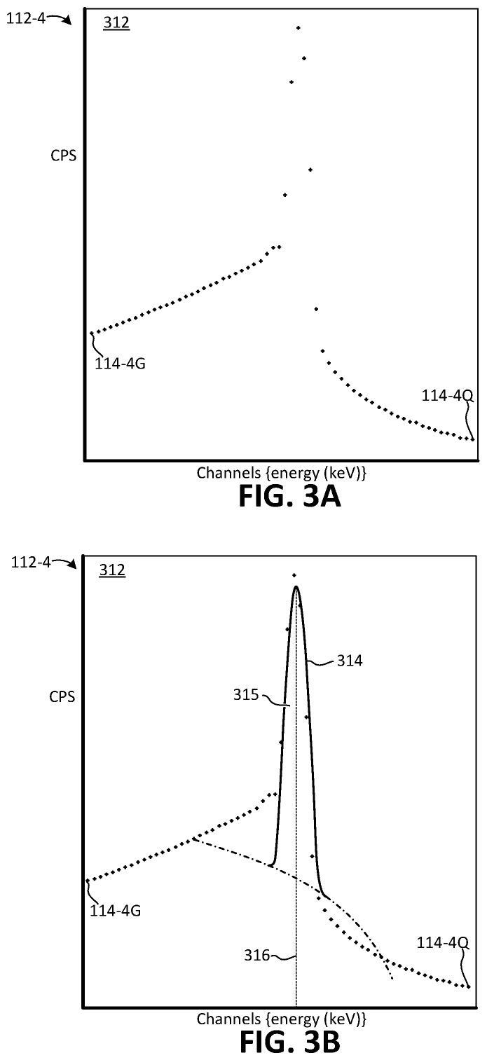

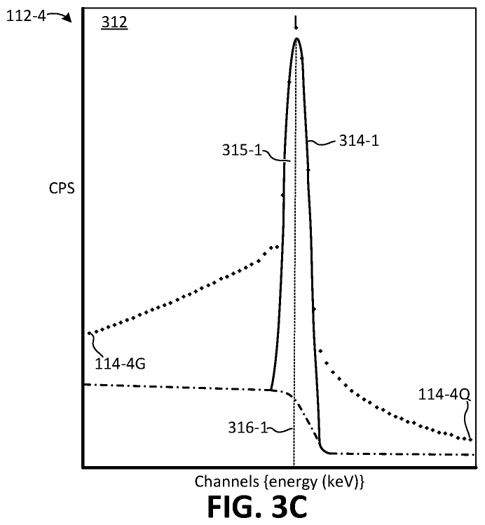

The ML module 110 may improve technical fields involving spectral analysis by, inter alia, obviating the need for numerical, human-interactive techniques. FIG. 3A illustrates an example of a region 312 of a gamma spectrum 112. The region 312 includes features 114-4G through 114-4Q which may comprise counts (or CPS) at respective spectrum channels. The region 312 may be extracted from a spectrum 112 comprising background signal(s) and a plurality of overlapping peaks, such as the spectrum 112-3 illustrated in FIG. 2C. Although it may be possible to identify peaks within individual regions 312 through numerical analysis (e.g., curve fitting), these techniques can introduce uncertainty and lead to error. For example, a peak within the region 312 may be modeled by fitting the features 114-4 to a mathematical model, such as a polynomial, spline, cubic spline, exponential, Gaussian function, and/or the like. As illustrated in FIG. 3B, the features 114-4 may be fit to a curve 314 centered at a determined peak energy 316. The area 315 under the curve 314 may correspond to emission at the determined peak energy 316. These numerical techniques, however, can become unreliable due to background noise, geometry changes, measurement rate (e.g., high or low count rate), spectra 112 having multiple overlapping peaks (spectra 112 of subjects 109 comprising multiple radioisotopes, as illustrated in FIG. 2C), and so on. Although efforts have been made to improve the accuracy of numerical curve fitting techniques, even these improved approaches rarely obtain acceptable uncertainty (3% or less at 68% confidence) in even the most ideal conditions. For example, the uncertainty of the curve 314 illustrated in FIG. 3B may be about 9.07%.

Although human intervention can improve the accuracy of numerical curve fitting techniques, these approaches are not feasible in many applications and are subject to human bias and/or error. FIG. 3C illustrates an example of a curve 314-1 obtained through an interactive curve fitting procedure (a curve 314-1 at a peak energy of 316-1, corresponding to an activity or area 315-1). The uncertainty of the interactive fit may be about 2.77% (a reduction of 5.3% as compared to the automated fit example of FIG. 3B). However, even small curve fitting errors can lead to significant analysis errors. For example, as shown in FIG. 2C, the peak energies of some radioisotopes may be closely spaced, meaning that relatively small errors in peak energy (e.g., 316 or 316-1) may result in radioisotope misidentification. Similarly, relatively minor errors in the numerical model (in curve 314 or 314-1) may result in significant differences in detected emission level (error in area 315 or 315-1). Moreover, due to the need for expert human intervention, interactive analysis techniques may not be scalable. For example, interactive spectral analysis may take many days to complete even by highly trained personnel. Moreover, complicated spectra 112 often must be re-analyzed; experts may examine initial spectrum analysis results and use their experience and expertise to draw conclusions about the presence and quantities of radioisotopes that may not be detected through conventional automated, or even interactive spectrum analysis.

The ML spectrum analysis technology disclosed herein can address these and other shortcomings. Referring back to FIG. 1, the ML module 110 may quantify activity at designated energy levels (at energies corresponding to respective labels 124) with high accuracy and without the need for human intervention or re-analysis). In some implementations, the ML module 120 may comprise and/or be coupled to an artificial neural network (ANN).

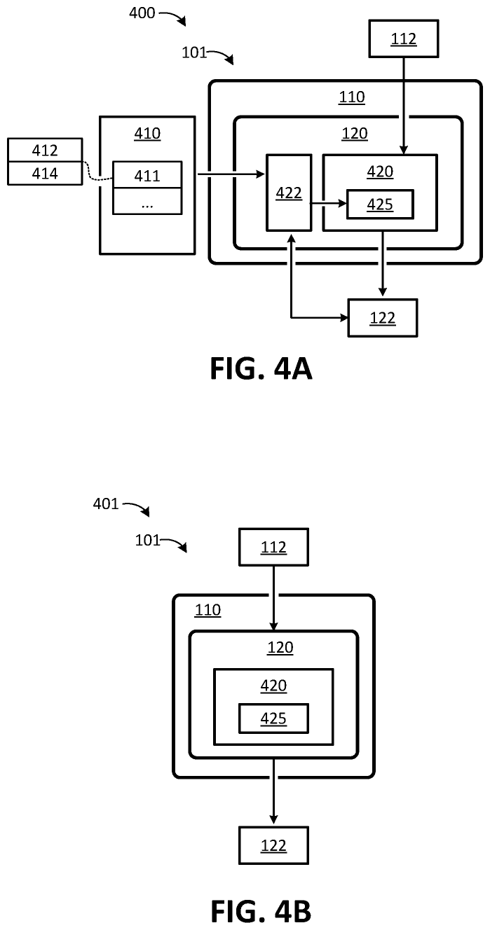

FIG. 4A illustrates an example 400 of an apparatus 101 configured to implement aspects of ML spectrum analysis. In the FIG. 4A example, the ML module 120 comprises and/or is coupled an ANN 420. The ANN 420 may comprise nodes (artificial neurons). The nodes may be interconnected and/or organized within respective layers of the ANN 420, including an input layer, one or more hidden layers, an output layer, and so on. Nodes of the ANN 420 may be configured to implement hierarchical ML learning functions (activation functions). The ANN 420 may comprise nodes configured to implement any suitable activation function. In some implementations, nodes of the ANN 420 are configured to implement Rectified Linear Unit (ReLU) activation or the like. In some embodiments, performance of the ML module 120 may be improved by configuring nodes of the ANN 420 to implement hyperbolic tangent (tanh) ML activation functions, as follows:

$$tanh ( x ) = \frac{{e}^{x} - {e}^{- x}}{{e}^{x} + {e}^{- x}} .$$

The ANN 420 may be configured to produce spectrum analysis data 122 in response to input spectra 112. The spectrum analysis data 122 may comprise predictions for respective labels 124 (e.g., prediction data 126-1 through 126-N for respective labels 124-1 through 124-N as disclosed herein). The labels 124 may correspond to characteristic radiation energies of respective radioisotopes of interest. The prediction data 126 determined for each label 124 may comprise an activity quantity, the activity quantity configured to quantify emission of radiation at the characteristic radiation energy the label 124 (and/or characteristic radiation energy of the radioisotope represented by the label 124). Accordingly, the activity quantities determined for a radiation spectrum 112 acquired from a subject 109 may indicate quantities of respective radioisotopes within the subject 109 (since the activity quantity determined for the respective radioisotopes by the labels 124 are proportional to the amount and/or concentration of the respective radioisotopes).

In some implementations, the ANN 420 may comprise a first hidden layer. The first hidden layer may have a higher resolution or density than the input layer of the ANN 420. In other words, the first hidden layer may comprise more nodes than the input layer of the ANN 420.

In some embodiments, the ANN 420 may be trained to predict a plurality of labels 124, each label 124 configured to represent a different radioisotope; each label 124 may be configured to represent a respective radioisotope of a plurality of radioisotopes (e.g., each label 124 may correspond to a different radioisotope). The prediction data 126 determined for each label 124 be configured to quantify emission of radiation at energy level(s) characteristic of the radioisotopes represented by each label 124. In other words, the prediction data 126 determined for a particular label 124 may quantify an activity and/or emission of radiation at the radiation energy level(s) characteristic of the radioisotope represented by the particular label 124.

Alternatively, the ANN 420 may be trained to predict labels 124 configured to represent multiple emission levels of respective radioisotopes. In these examples, particular radioisotope may be represented by a plurality of different labels 124, each label 124 representing a respective emission level (or activity) of the particular radioisotope. For example, the output layer of the ANN 420 may include N nodes (for each of N labels 124), where N=R×L, R is the number of unique radioisotopes the ANN 420 is trained to detect, and L is the number of different emission levels of each radioisotope the ANN 420 can distinguish (assuming the ANN 420 is trained to distinguish between L activity levels for each radioisotope). In some implementations, the ANN 420 may be configured to detect different numbers of emission levels for respective radioisotopes; the ANN 420 may include N nodes (or N labels 124), where N=Σᵢ₌₁^{R} Lᵢ and Lᵢ is the number of emission levels the ANN 420 is trained to detect for radioisotope i of R different radioisotope types.

As illustrated in FIG. 4A, the ML module 120 may comprise and/or be coupled to an ML training engine 422. The ML training engine 422 trains the ANN 420 to produce spectrum analysis data 122 that accurately distinguishes radioisotopes (and/or microcurie emissions thereof) within spectrum data 112 captured from subjects 109 having unknown compositions. The ML training engine 422 may develop a machine-learned (ML) configuration 425 for, inter alia, the ANN 420 by use of training data (a training dataset 410), such as spectrum data 112 captured from subjects 109 having known radioisotope compositions. The ML configuration 425 may include any suitable information pertaining to the ANN 420 and/or other components of the ML module 110. The ML configuration 425 may comprise hyperparameters configured to define one or more of: the architecture of the ANN 420, the structure of the ANN 420, the configuration of respective layers of the ANN 420 (e.g., the configuration of an input layer, hidden layer(s), and output layer of the ANN 420), the types of layers included in the ANN 420 (e.g., convolutional layers, linear layers, and/or the like), the number of hidden layers included in the ANN 420, the quantity of nodes included in respective layers of the ANN 420, interconnections between respective layers of the ANN 420 (e.g., fully connected, non-fully connected, sparsely connected, or the like), activation functions implemented by nodes of respective layers of the ANN 420, an initial learning rate, regularization strength, neuron dropout rate, and/or the like. The ML configuration 425 may further comprise node-specific configuration data, such as activation function weights learned for respective nodes and so on.

As disclosed in further detail herein, the ANN 420 may be configured to learn an ML configuration 425 through a training process. The ML configuration 425 may be adapted to configure the ANN 420 to accurately predict labels 124, as disclosed herein (e.g., produce accurate predication data 126). The ANN 420 may be trained using a training dataset 410 may include any suitable information for use in training, validating, testing, refining, and/or otherwise learning an ML configuration 425 that enables the ANN 420 to produce accurate spectrum analysis data 122. As illustrated in FIG. 4A, the training dataset 410 can include a plurality of entries 411, each entry 411 including inter alia, respective training spectrum data 412 and corresponding training metadata 414. The training spectrum data 412 of an entry 411 may include spectrum data 112, such as channel data, an image representation 212 or the like, as disclosed herein. The training metadata 414 may specify the radioisotope(s) and/or radioisotope emission level(s) captured within the training spectrum data 412 of the entry 411. The training metadata 414 may, therefore, include a ground truth, classification, or label of the training spectrum data 412. In some implementations, the training dataset 410 is constructed from spectrum data 112 acquired from subjects 109 having known radioisotope compositions, from previously determined (and/or verified) spectrum analysis operations, and/or the like. Alternatively, or in addition, the ML module 120 may produce portions of the training dataset 410 from synthetic spectrum data. In some examples, the ML training engine 422 derives synthetic spectrum data from acquired training spectrum data 412 (e.g., by introducing noise, background signal(s), and/or other perturbations into the acquired training spectrum data 412).

The ML training engine 422 may learn the ML configuration 425 and/or otherwise train the ANN 420 through any suitable training procedure, technique, and/or algorithm. In some implementations, the ML training engine 422 implements a training procedure that incorporates binary cross-entropy as the loss function and utilizes Adam optimization. Alternatively, or in addition, the ML module 120 may implement a training, validation, or test procedure in which entries 411 of the training dataset 410 are divided into a training set (about 80%), test set (about 10%), and validation set (about 10%). The ML training engine 422 may implement an iterative training procedure that includes one or more training phases, validation phases, and/or and testing phases. A training phase may include one or more epochs, each epoch including inputting entries 411 of the training set into the ANN 420 and evaluating the corresponding spectrum analysis data 122 produced by the ANN 420. The evaluating may include determining error metrics (training error) to quantify differences and/or distances between the spectrum analysis data 122 produced by the ANN 420 in response to training spectrum data 412 of respective entries 411 and the training metadata 414 of the respective entries 411. The error metrics may be determined by comparing a) the radioisotope types and/or microcurie emissions specified by training metadata 414 of the respective entries 411 to b) the radioisotope types and/or microcurie emissions generated by the ANN 420 in response to training spectrum data 412 of the entries 411. The error metrics may quantify error, differences, and/or distance using any suitable mechanism including, but not limited to Euclidian distance, root mean square (RMS), and/or the like. The ML training engine 422 may continue the training phase until one or more training criteria are satisfied (e.g., weights of the ANN 420 converge to stable values, a threshold is reached, and/or the like).

The ML training engine 422 may use the error metrics to, inter alia, learn and/or refine the ML configuration 425. In some implementations, the ML training engine 422 implements an optimization algorithm that adjusts weights and/or other parameters of the ML configuration 425 to produce reduced error metrics. The ML training engine 422 may implement any suitable training and/or optimization algorithm including, but not limited to: gradient descent, batch gradient descent, stochastic gradient descent, Adam optimization, or the like. The optimization algorithm may incorporate any suitable cost or loss function, such as a binary cross-entropy as the loss function or the like. The ML module 120 may adjust the ML configuration 425 through the optimization algorithm in response to completing: an epoch (after processing the training entries 411 included in the training set), a plurality of epochs, one or more sub epochs (after processing a subset of the entries 411 of the training set), and/or the like. The ML module 120 may continue the training phase until one or more training-phase criteria are satisfied (e.g., weights of the ANN 420 converge to stable values, a threshold is reached, and/or the like).

The ML training engine 422 may be further configured to implement validation phases in response to completion of respective training phases. A validation phase may include evaluating spectrum analysis data 122 produced by the ANN 420 (as trained in the training phase) in response to entries 411 of the validation set, which, as disclosed herein, may include a separate subset of the training dataset 410 from the training set utilized in the training phase. Error metrics determined during the validation phase may be used to validate the ML configuration 425 learned in the preceding training phase (e.g., may indicate at learn rate of the ANN 420 and/or training procedure). The ML training engine 422 may be further configured to utilize the error metrics determined during validation phases to iteratively implement training and validation phases until the ANN 420 converges to a local or global minima (or some other validation-phase criteria are satisfied). The ML module 120 may implement test phases in response to completion of validation phases. A test phase may include using entries 411 of the test set to determine an unbiased evaluation of the ML configuration 425 of the ANN 420 learned through the preceding training and validation phases. Error metrics determined during the test phase may indicate an error rate of the ANN 420 when used to generate spectrum analysis data 122 in response to actual, unclassified spectrum data 112 (per the learned ML configuration 425).

The ML module 120 may utilize the ML configuration 425 learned during training to configure the ANN 420 to generate spectrum analysis data 122 that accurately distinguishes radioisotopes (and/or microcurie emissions thereof) of a subject 109 in response to spectrum data 112 acquired from the subject 109. The ML configuration 425 may be used to configure other instances of the ANN 420 operating on and/or within other instances of the apparatus 101, ML module 120, and/or ML module 110. The ML configuration 425 may be maintained on and/or within a non-transitory storage medium, such as NT storage resources 105 of the device 101. Although particular examples of ML training procedures are described herein, the disclosure is not limited in this regard and could be adapted to use and/or incorporate any suitable machine-learning mechanisms, techniques, and/or algorithms.

FIG. 4B illustrates another example 401 of an apparatus 101 for implementing ML spectrum analysis, as disclosed herein. In the FIG. 4B example, the ML module 120 implements an ANN 420 learned through one or more previously completed training procedure(s). More specifically, the ML module 120 configures the ANN 420 to implement a pre-determined ML configuration 425. The ML module 120 may load the ML configuration 425 from memory, non-transitory storage, network-accessible storage, and/or the like. Loading the ML configuration 425 may include instantiating the ANN 420 and configuring weights, biases, and/or other parameters of respective nodes of the ANN 420 per the ML configuration 425. The ML module 110 may utilize the ML configuration 425 to accurately distinguish radioisotopes and/or microcurie emissions thereof, as disclosed herein. The ML module 110 receives spectrum data 112 acquired from a subject 109 and, in response, instantiates and/or configures the ANN 420 (if not already instantiated), feeds the spectrum data 112 into an input layer of the ANN 420, and outputs spectrum analysis data 122 generated at an output layer of the ANN 420.

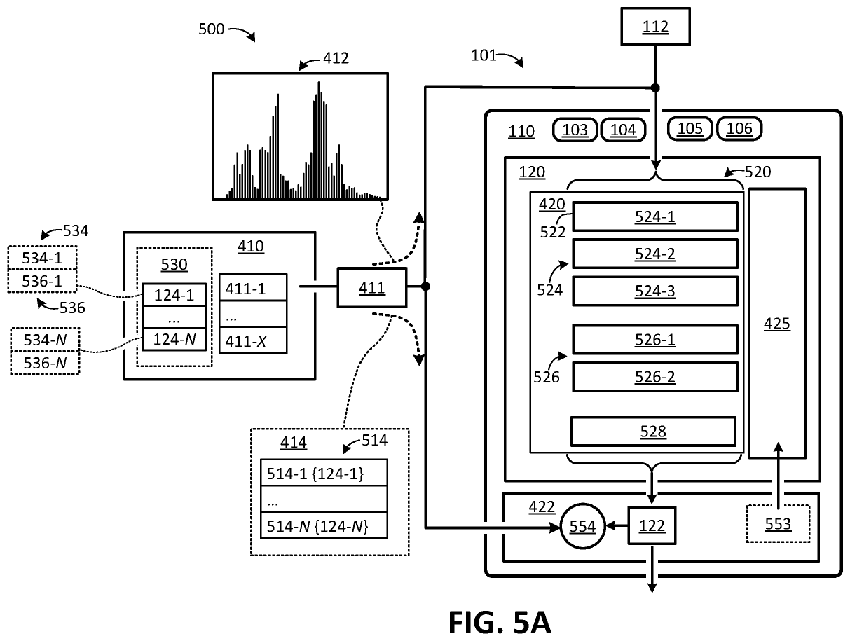

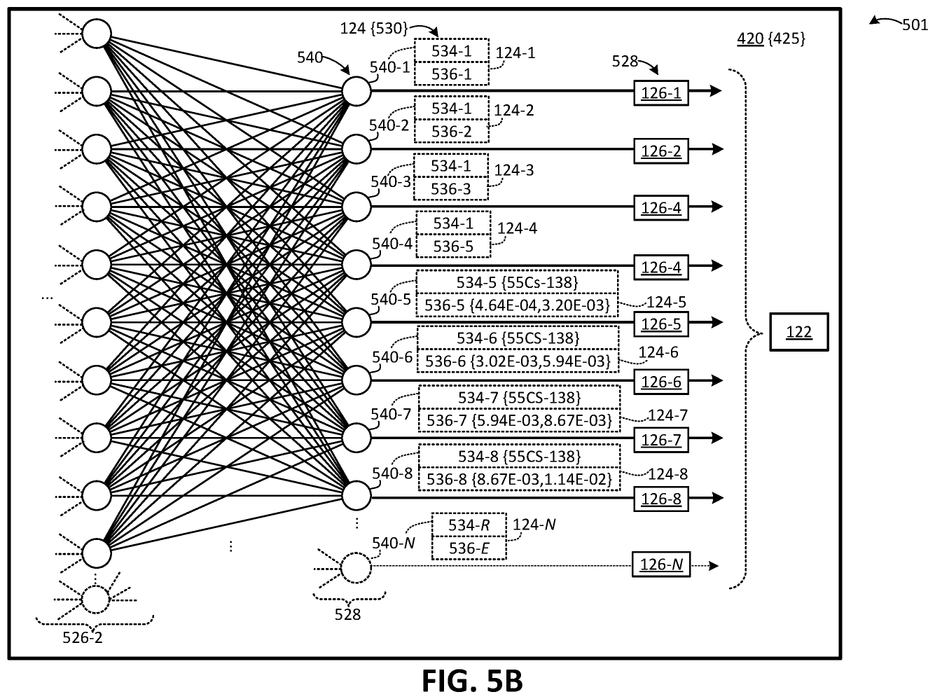

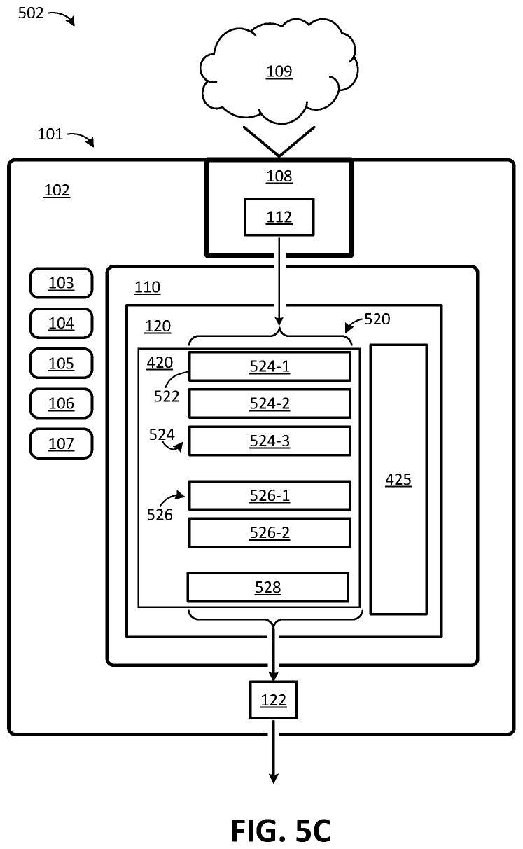

FIG. 5A illustrates another example 500 of an apparatus 101 for ML-enabled spectrum analysis, as disclosed herein. In the FIG. 5A example, the ML module 110 includes a ML module 120 configured to implement and/or instantiate an ANN 420. The ML module 120 may include any suitable processing means including, but not limited to: a computing device, a processor, a general-purpose processor, a CPU, a special-purpose processor, an ASIC, programmable processing elements, an FPGA, an ML processor, an ML platform, an ML environment, and/or the like. The ML module 120 may configure the ANN 420 to implement a convolutional neural network (CNN) architecture, including interconnected nodes arranged hierarchically within respective layers 520 (nodes and interconnections between nodes within different layers 520 not shown in FIG. 5A to avoid obscuring details of the illustrated examples). In the FIG. 5A implementation, the ANN 420 includes an input layer 522, one or more convolutional layers 524 (e.g., three convolutional layers 524A through 524-3), one or more dense layers 526 (e.g., two dense layers 526-1 and 526-2), an output layer 528, and/or the like.

In some implementations, the convolutional layer 524A may be configured as the input layer 522 of the ANN 420. The convolutional layer 524A (input layer 522) may include nodes corresponding to respective pixels 214 of spectrum image representations 212 included in the spectrum data 112 and/or training spectrum data 412 (each node of the convolutional layer 524A configured to receive a respective pixel as input). The number of nodes included in the input layer 522 (e.g., convolutional layer 524A) may be M, where M is the size of the spectrum image representation 212 in pixels (or M=W*H, where W and H are the width and height of the image representation 212, respectively).

The convolutional layers 524 may have any suitable configuration. In some implementations, the convolutional layers 524 are configured to implement a 25% dropout probability and a two-dimensional (2D) max pooling on a kernel of size two. The dense layers 526 may be configured to implement a 50% dropout probability with ReLU activation functions. The output layer 528 may be a dense layer including nodes that implement sigmoid activation functions.

As disclosed herein, ANN 420 can be configured to distinguish a plurality of radioisotope types as well as emission levels of the respective radioisotope types. As illustrated in FIG. 5A, the ANN 420 can be trained to distinguish a spectrum analysis classification vocabulary (vocabulary 530) that defines a plurality of labels 124, each label 124 of the vocabulary 530 corresponding to a respective radioisotope type 534 and/or an emission range or level 536 of the radioisotope type 534.

The ML training engine 422 learns an ML configuration 425 capable of distinguishing the labels 124-1 through 124-N. The ML training engine 422 can implement any suitable training procedure, as disclosed herein (e.g., a train, validate, and test procedure with binary cross-entropy as the loss function and Adam optimization).

The ML module 120 can utilize the machine-learned ML configuration 425 to construct an ANN 420 capable of distinguishing labels 124-1 through 124-N of the vocabulary. The output layer 528 of the ANN 420 may include a plurality of nodes, each configured to produce an output corresponding to a respective one of the labels 124-1 through 124-N. FIG. 5B, illustrates portions of an example 501 of an ANN 420 adapted to implement a machine-learned ML configuration 425, as disclosed herein. More specifically, FIG. 5B illustrates nodes 540 within an output layer 528 and adjacent dense layer 526-2 of the ANN 420. Other layers 520 of the ANN 420, such as convolution layers 524A through 524-3 and/or the dense layer 526-1 are not illustrated to avoid obscuring details of the described examples).

As illustrated, the output layer 528 includes N nodes 540, each node 540-1 through 540-N may correspond to a respective one of the labels 124 of the vocabulary 530 the ANN 420 is trained to distinguish (per the ML configuration 425). Outputs produced by nodes 540 of the output layer 528 in response to spectrum data 112 may quantify a probability that the spectrum data 112 includes the label 124 associated with the node 540 or, more specifically, that the spectrum data 112 includes radiation characteristic of the radioisotope type 534 and emission level 536 of the corresponding label 124. The quantities output by the nodes 540 of the output layer 528 may, therefore, be referred to as label classifications, predictions, estimates, or the like (predictions 126). In the FIG. SB implementation, the output layer 528 produces N predictions 126 (126-1 through 126-N), each quantifying a probability that input spectrum data 112 includes a respective label 124 of the vocabulary 530; or, more specifically, each quantifying a probability that the input spectrum 112 includes radiation produced by the radioisotope type 534 and emission level 536 of the corresponding label 124. The spectrum analysis data 122 may incorporate the prediction data 126 produced by the output layer 528. As illustrated in FIG. 5B, the spectrum analysis data 122 may include N predictions 126 (126-1 through 126-N). The ANN 420 may, therefore, be capable of predicting, estimating, and/or distinguishing a plurality of radioisotope types 534 at a plurality of emission levels 536 within input spectrum data 112 at least partially in parallel. As disclosed herein, the emission levels 536 of detected radioisotope types may correspond to an amount, quantity, state, and/or configuration of the detected radioisotope types. The spectrum analysis data 122 may, therefore, both a) identify radioisotopes within subjects 109 and b) quantify the identified radioisotopes.

The ANN 420 constructed by the ML module 120 (and/or trained by the ML training engine 422) may be sparse and/or non-fully connected due to, inter alia, the inclusion of dropout layers 520 (e.g., convolution layers 524 and/or dense layers 526 having non-zero dropout probabilities). In contrast to fully connected architectures, such as those used in image classification, ANN 420 may be capable of learning spatial structure. Moreover, inclusion of multiple output nodes for each of a plurality of radioisotope types 534 can enable the ANN 420 to distinguish between a plurality of radioisotope types 534 and/or distinguish between a plurality of emission levels 536 of each of the plurality of radioisotope types 534 simultaneously and/or substantially in parallel.

In the FIG. 5B example, the output layer 528 of the ANN 420 includes output nodes 540-1 through 530-4 to distinguish respective emission levels 536-1 through 536-4 characteristic of a first radioisotope type 534A (per labels 124-1 through 124-4 of the vocabulary 530). The predictions 126-1 through 126-N produced in response to a spectrum 112 may, therefore, indicate a probability that the spectrum 112 includes radiation characteristic of the first radioisotope type 534A within each of the emission levels 536-1 through 536-4. By way of further example, nodes 540-5 through 540-8 are configured to distinguish respective emission levels of a second radioisotope type 534-2 (a radioisotope of Cesium, 55CS-138), per labels 124-5 through 124-8 of the vocabulary 530. The predictions 126-5 through 126-8 produced in response to the spectrum data 112 may, therefore, quantify a probability that the spectrum data 112 includes radiation characteristic of 55CS-138 at each emission level 536-5 through 536-8. Node 540-N of the output layer 528 may correspond to label 124-N of the vocabulary 530 and, as such, be configured to produce prediction data 126-N corresponding to radioisotope type 534-R at emission level 536-E, where R is the number of distinct radioisotope types 534 within the vocabulary 530 and E is the number of emission levels 536 distinguished for respective radioisotope types 534 (or for radioisotope type 534-4).

Referring back to FIG. 5A, the ML training engine 422 can learn an ML configuration 425 for the ANN 420 that produces accurate spectrum analysis data 122 in response to, inter alia, training spectrum data 412 of a training dataset 410. The training dataset 410 may include a plurality of entries 411, each entry 411 including training spectrum data 412, such as a spectrum image representation 212, and corresponding training metadata 414. The training metadata 414 can specify values for respective labels 124 of the vocabulary 530 (specify ground-truth (GT) values 514), each GT value 514 indicating whether the corresponding training spectrum data 412 includes and/or corresponds to a respective one of the labels 124 of the vocabulary 530. In the FIG. 5A example, the training metadata 414 corresponding to the training spectrum data 412 of an entry 411 (a spectrum image representation 212) may include N GT values (GT values 514-1 through 514-N), each indicating whether the spectrum data 412 includes characteristic radiation of the radioisotope type 534 and/or emission level 536 of a respective one of the N labels 124 of the vocabulary 530. In some implementations, the GT values 514 may include binary values, with a “1” indicating that the training spectrum data 412 corresponds to the label 124 and a “0” otherwise. Alternatively, or in addition, the GT values 514 may quantify a probability that the training spectrum data 412 corresponds to respective labels 124 (within a range been 0 and 1). The ML training engine 422 can configure the training dataset 410 to span the vocabulary 530 by, inter alia, configuring the training dataset 410 to include entries 411 that correspond to each label 124-1 through 124-N of the vocabulary (and/or combinations thereof). In one example, the training dataset 410 includes about 9000 spectra, with about 8000 entries 411 being included in a training set and about 1000 entries 411 being included in a test and/or validation set.

The ML training engine 422 may implement an iterative training process, as disclosed herein. Iterations of the training process may operate on entries 411 of a subset of the training dataset 410. Processing an entry 411 of the training dataset 410 may include: a) inputting training spectrum data 412 of the entry 411 into the ANN 420 (inputting a spectrum image representation 212 of the training spectrum data 412 at the input layer 522 of the ANN 420), b) configuring the ANN 420 to process and/or propagate the training spectrum data 412 to, inter alia, produce spectrum analysis data 122 at the output layer 528, and c) determining error metrics 553 that quantify error, differences, and/or distances between the training metadata 414 of the training spectrum data 412 and the spectrum analysis data 122 produced by the ANN 420. In some implementations, the ML training engine 422 includes and/or is coupled to comparator logic 554 that produces error metrics 553 by, inter alia, comparing GT values 514 of the training metadata 414 to corresponding predictions 126 of the spectrum analysis data 122. The ML training engine 422 may utilize the error metrics 553 to train, refine, test, and/or validate the ANN 420 and/or ML configuration 425, as disclosed herein (e.g., in accordance with an optimization algorithm, such as Adam optimization, or the like).

The ML module 110 can be configured to operate in one or more modes, including a training mode and an operational mode. In the training mode, the ML module 110 utilizes training spectrum data 412 and corresponding training metadata 414 to train and/or refine the ANN 420 and/or ML configuration 425. The ML module 110 may transition to the operational mode in response to completing one or more training processes and/or importing a machine-learned ML configuration 425 (learned in one or more previous training processes). In the operational mode, the ML module 110 receives spectrum data 112 and outputs spectrum analysis data 122, as disclosed herein. The spectrum analysis data 112 may include a plurality of prediction datum 126, each quantifying a probability that the spectrum data 112 includes radiation characteristic of the radioisotope type 534 and emission level 536 of a respective label 124.

FIG. 5C illustrates another example 502 of an apparatus 101 for ML-enabled spectrum analysis, as disclosed herein. In the FIG. 5C implementation, the ML module 110 is realized by and/or within a device 101 that includes computing resources 102, such as processing resources 103, memory resources 104, NT storage resources 105, HMI resources 106, a data interface 107, and/or the like. The device 101 may be, include and/or be coupled to an acquisition device 108 configured to acquire spectrum data 112 from subjects 109. The ML module 110 is configured to produce spectrum analysis data 122 in response to the spectrum data 112 by use of a ML module 120. The ML module 120 instantiates, configures, and/or otherwise manages implementation of an ANN 420. The ML module 120 may instantiate and/or configure the ANN 420 in accordance with a predetermined ML configuration 425. The ML configuration 425 may have been learned in one or more previously completed training processes, as disclosed herein. The ML module 120 can load the ML configuration 425 from memory resources 104, NT storage resources 105, and/or the like. Alternatively, or in addition, the ML module 120 can receive the ML configuration 425 through the data interface 107 of the device 101. In some implementations, the ANN 420 and/or ML configuration 425 are encoded within hardware components of the device 101, such as an ASIC, FPGA, and/or the like. Alternatively, the ANN 420 may be instantiated within memory and/or be implemented by use of the processing resources 103 of the device 101. The ANN 420 is configured to produce spectrum analysis data 122 in response to spectrum data 112 obtained by the acquisition device 108. The spectrum analysis data 122 may include a plurality of prediction datum 126, each quantifying a probability that the subject 109 includes an emission source characteristic of a respective radioisotope type 534 and/or emission level 536 of the respective radioisotope type 534. The ML module 110 may, therefore, distinguish a plurality of emission levels 536 of a plurality of radioisotope types 534 at least partially in parallel. In some implementations, the ML module 110 is further configured to display a graphical representation of the spectrum analysis data 122 on one or more HMI resources 106 of the device 101, such as a display screen or the like. Alternatively, or in addition, the ML module 110 can record the spectrum analysis data 122 in memory resources 104 and/or NT storage resources 105, transmit the spectrum analysis data 122 on a network (through the data interface 107), and/or the like.

In some implementations, the ML training engine 422 may be further configured to determine bias weights for nodes 540 of the ANN 420. The bias weights may be configured to adapt the ANN 420 to training bias, e.g., higher rate of occurrence of some labels 124 relative to other labels. The ML training engine 422 may, therefore, determine bias weights for respective labels 124 based on the occurrence of the labels 124 within the training dataset 410. Labels 124 that occur less frequently may be weighted relative to other labels 124 that occur more frequently in the training dataset 410. In some implementations, the bias weights may be determined in accordance with the following pseudocode: weights=torch.as_tensor([1/np.mean(labels[i_train][:, j])/32 for j in range(32)], dtype=torch.float32, device=torch.device(‘cuda’)), where i_train is the dataloader frame (or training dataset 410) of interest; for each epoch, evaluate the model ŷ=model(x); compute the loss, as loss=loss_fn(ŷ, y); scale the loss by the adjusted bias weights, loss=(loss*weights).mean( ); proceed with stochastic gradient descent (or other training algorithm, e.g. loss.backward( ), optimizer.step( ). The bias weights may be incorporated into nodes 540 during training and implementation.

The loss function may be adapted for spectral analysis. In some implementations, the loss function may comprise a sigmoid layer in combination with binary cross entropy (e.g., BCEWithLogitsLoss or the like). The ANN 420 may be further configured to handle large variations between spectra 112 (and/or spectrum energies). The ANN 420 may comprise a scalar, such as StandardScaler( ) over which a partial fit on the data may be run on respective training epochs (e.g., scaler.partial_fit(x) and transform every epoch). Alternatively, or in addition, the ANN 420 may operate on log values of spectral activity (features 114), after adding a 1 to each feature 114 to avoid taking a log of 0, as follows: y_label=np.array(labels.drop([‘id’], axis=1)); y_background=np.zeros((len(x_background), 32)); y+=1; y=np.log(y); y.shape.

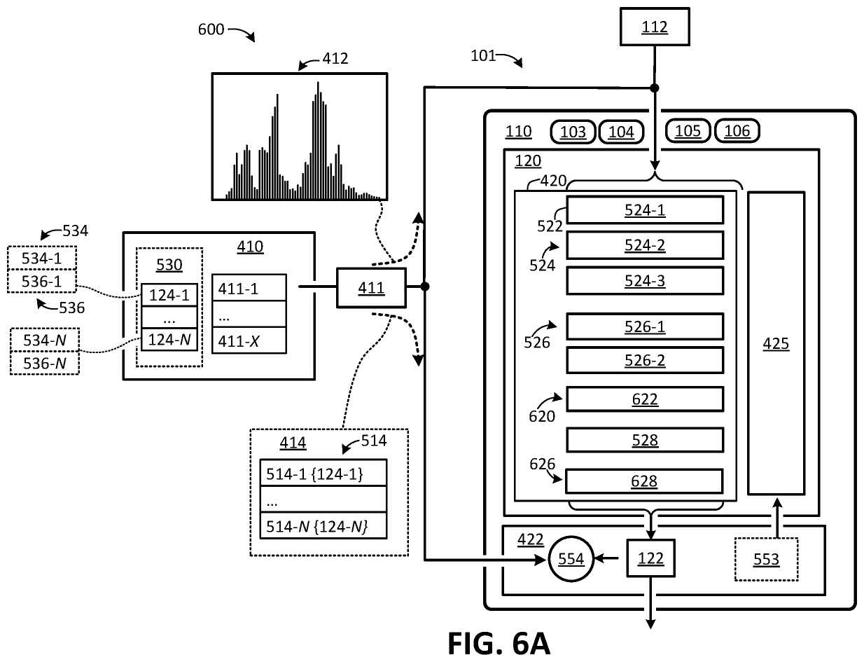

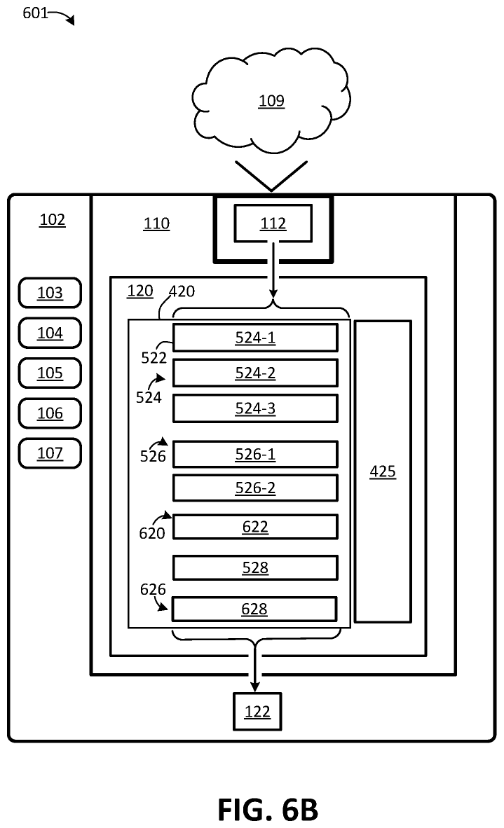

FIG. 6A illustrates another example 600 of an apparatus 101 for ML-enabled spectrum analysis, as disclosed herein. The apparatus 101 may include a spectrum analyzer 111, which may include a ML module 120 configured to implement an ANN 420 that includes interconnected nodes arranged within respective layers 520, including an input layer 522, one or more convolutional layers 524 (e.g., three convolutional layers 524A through 524-3), one or more dense layers 526 (e.g., two dense layers 526-1 and 526-2), an output layer 528, and/or the like. In the FIG. 6A example, the ML module 120 configures the ANN 420 to implement a Recurrent Neural Network (RNN) architecture. The RNN architecture of the ANN 420 may include a Long Short-Term Memory (LSTM) network architecture. The ANN 420 may include one or more RNN layers 620, including an RNN layer 622. As illustrated, the RNN layer 622 may be disposed between the dense layers 526 and the output layer 528. The disclosure is not limited in this regard, however, and may adapt the ANN 420 to implement any suitable RNN architecture and/or incorporate any suitable type of RNN layer 620 at any suitable location and/or configuration. In some implementations, the ANN 420 may include a plurality of RNN layers 622 disposed between the dense layers 526 and output layer 528, may include RNN layer(s) 620 disposed between the convolutional layers 524 and the dense layers 526, may include RNN layer(s) 620 configured as an input layer(s) 522, may include RNN layer(s) 620 configured as the output layer(s) 528 of the ANN 420, and/or the like.

As disclosed herein, the ML training engine 422 can train the ANN 420 to distinguish a spectrum analysis classification vocabulary (vocabulary 530) that defines a plurality of classification labels (labels 124), each label 124 of the vocabulary 530 corresponding to a respective radioisotope type 534 and/or an emission range or level 536 of the radioisotope type 534. In the FIG. 6A example, the ML training engine 422 can train the ANN 420 to utilize the RNN layer(s) 620 to increase the sensitivity of the ANN 420 in identifying and quantifying radioisotopes that are present in pairs or groups. In some implementations, the ML training engine 422 learns an ML configuration 425 that configures RNN layer(s) 620 of the ANN 420 to interpret temporal, spatial-temporal, sequential, and/or spatial-sequential characteristics of spectrum data 112. The RNN layers 620 may use temporal and/or sequential information to improve predictions (e.g., improve the accuracy of the prediction data 126 generated by the ANN 420).

In the FIG. 6A example, the spectrum analyzer 111 may further include one or more classification component and/or layer(s) (classification layer(s) 626). The classification layers 626 may be coupled to the output layer 528 layer of the ANN 420. Alternatively, the classification layer(s) 626 may implement and/or incorporate the output layer 528. As illustrated, the classification layer(s) 628 may generate outputs of the ANN 420, such as the spectrum analysis data 122, as disclosed herein. In some implementations, the classification layer(s) 626 include a connectionist temporal classification (CTC) layer 628. CTC component, CTC network, and/or the like. The classification layer 628 may include a CTC network having a continuous output (e.g., softmax), which may be fitted through training to model the probability of respective labels 124 of the vocabulary 530 (by the ML training engine 422). The ML configuration 425 learned by the ML training engine 422 may, therefore, include fit parameters (and/or other information) for the CTC layer 628.

FIG. 6B illustrates another example 601 of an apparatus 101 for ML-enabled spectrum analysis, as disclosed herein. In the FIG. 6B implementation, the ML module 110 is realized by and/or within a device 101 that includes computing resource, 102, such as processing resources 103, memory resources 104, NT storage resources 105, HMI resources 106, a data interface 107, and/or the like. The device 101 may be, include and/or be coupled to an acquisition device 108 configured to acquire spectrum data 112 from subjects 109. The ML module 110 is configured to produce spectrum analysis data 122 in response to the spectrum data 112 by use of a ML module 120. The ML module 120 instantiates, configures, and/or otherwise manages implementation of an ANN 420. The ML module 120 may instantiate and/or configure the ANN 420 in accordance with a predetermined ML configuration 425. The ANN 420 may include an input layer 522, one or more convolution layers 524, one or more dense layers 526, one or more RNN layers 620, including an RNN layer 622, an output layer 528, and so on. The ANN 420 may further include one more classification layers 626, including a CTC layer 628, as disclosed herein.

The ML module 120 instantiates and/or adapts the ANN 420 in accordance with the ML configuration 425. The ML configuration 425 may have been learned in one or more previously completed training processes, as disclosed herein. The ML module 120 can load the ML configuration 425 from memory resources 104, NT storage resources 105, and/or the like. Alternatively, or in addition, the ML module 120 can receive the ML configuration 425 through the data interface 107 of the device 101. In some implementations, the ANN 420 and/or ML configuration 425 are encoded within hardware components of the device 101, such as an ASIC, FPGA, and/or the like. Alternatively, the ANN 420 may be instantiated within memory resources 104 and/or be implemented by use of a processor of the device 101.

The ANN 420 is configured to produce spectrum analysis data 122 in response to spectrum data 112 obtained by the acquisition device 108. The spectrum analysis data 122 may include a plurality of prediction datum 126, each quantifying a probability that the subject 109 includes an emission source characteristic of a respective radioisotope type 534 and/or emission level 536 of the respective radioisotope type 534. The ML module 110 may, therefore, distinguish a plurality of emission levels 536 of a plurality of radioisotope types 534 at least partially in parallel. The spectrum analysis data 112 may include a plurality of predictions 126, each quantifying a probability that the subject 109 includes a specified radioisotope type 534 of a plurality of radioisotope types 534 at a designated emission level 536 of a plurality of emission levels 536 of the specified radioisotope type 534. The emission level 536 of a radioisotope type 534 may correspond to an amount, quantity, state and/or configuration of the radioisotope type 534 within the subject 109. The spectrum analysis data 412 may, therefore, identify one or more radioisotope types 534 within the subject 109 and quantify the identified radioisotopes 534 (per the emission levels 536 of the identified radioisotope types 534).

In some implementations, the ML module 110 is further configured to display a graphical representation of the spectrum analysis data 122 on one or more HMI resources 106 of the device 101, such as a display screen or the like. Alternatively, or in addition, the ML module 110 can record the spectrum analysis data 122 in memory resources 104 and/or NT storage resources 105, transmit the spectrum analysis data 122 on a network (through the data interface 107), and/or the like.

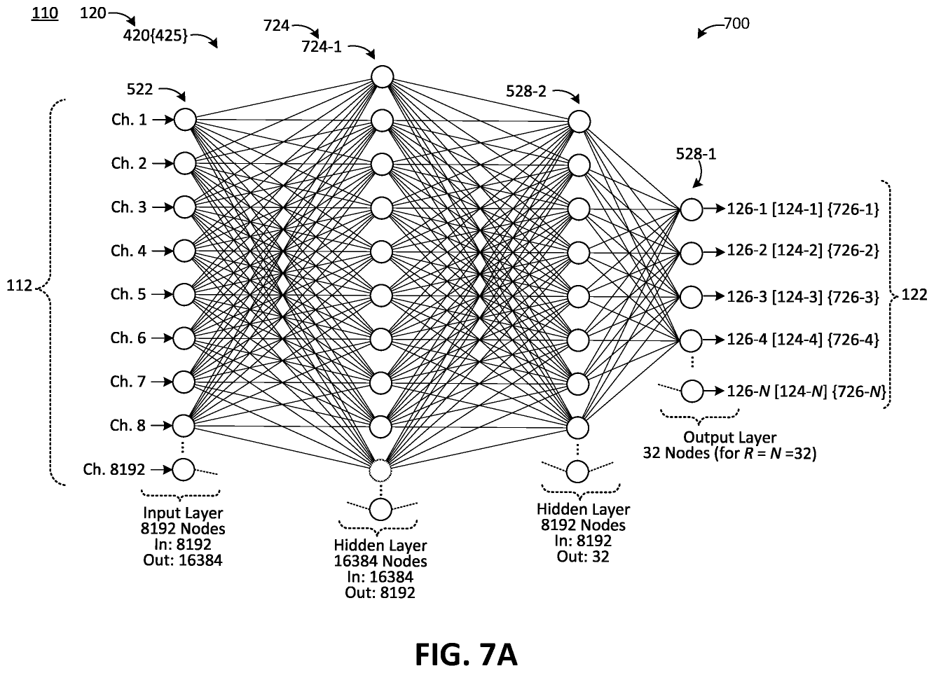

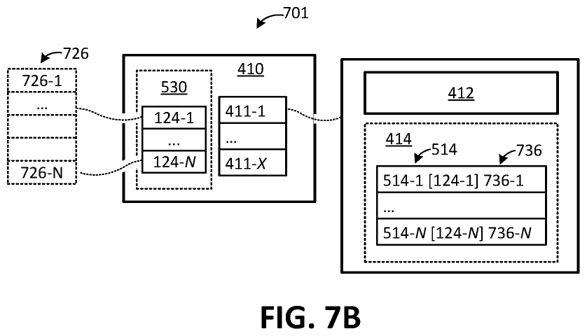

FIG. 7A illustrates another example 700 of an ML module 110. In the FIG. 7A example, the ANN 420 comprise an input layer configured to receive spectrum 112 data as a 1 by Ch array, where Ch is a number of channels in the spectra 112. In the FIG. 7A, the ANN 420 is configured to receive input data comprising spectra 112 of 8192 channels (e.g., 8192 values, each corresponding to a count, CPS, or other measure of radiation intensity at a respective one of 8192 channels).

The ANN 420 may further comprise one or more hidden layers 724. In the FIG. 7A example, the ANN 420 comprises a first hidden layer 724-1 and a second hidden layer 724-2. The first hidden layer 724-1 may comprise a larger number of nodes 540 than the input layer 522 (e.g., may be overprovisioned relative to the input layer 522). The first hidden layer 724-1 may comprise double the amount of nodes 540 as the input layer 522 (e.g., 16384 nodes 540 for an input layer 522 comprising 8192 nodes 540). In some implementations, the ANN 420 may further comprise a second hidden layer 724-2. The second hidden layer 724-2 may comprise fewer nodes 540 than the first hidden layer 724-1. In the FIG. 7A example, the second hidden layer 724-2 comprises about half the number of nodes 540 as the first hidden layer 724-1 (or about the same number of nodes 540 as the input layer 522).

The output layer 528 of the ANN 420 may comprise N nodes 540, each corresponding to a respective radioisotope type 534 (a respective one of N labels 124-1 through 124-N). The ANN 420 may correspond to the following pseudocode:

```
SpectroscopyModel(
  (net): Sequential(
    (0): Linear(in_features=8192, out_features=16384, bias=True)
    (1): Tanh( )
    (2): Linear(in_features=16384, out_features=8192, bias=True)
    (3): Tanh( )
    (4): Linear(in_features=8192, out_features=32, bias=True)
    (5): Softmax(dim=None)
  )
)
```

As illustrated above, nodes 540 of the ANN 420 may be configured to implement tanh activation functions. In contrast to the implementations illustrated in FIGS. 5A-6B, the layers 522, 524, and 528 of the ANN 420 may be fully connected. The ANN 420 illustrated in FIG. 7A may be significantly smaller and/or consume less ML configuration data 425 than the CNN implementations of FIGS. 5A-6B (e.g., due to use of simplified input data relative to the image representations described above). In further contrast to the implementations illustrated in FIGS. 5A-6B, the ANN 420 may be configured to generate prediction data 126 comprising activity quantities 726 for each label 124 (or each radioisotope type 534). The activity quantities 726 determined for the labels 124 may be configured to quantify emission of radiation characteristic of the radioisotope types 534 represented by the labels 124. In other words, each radioisotope type 534 may be represented by a single one of the labels 124; the activity quantities 726-1 through 726-N may quantify activity and/or emission at characteristic energy ranges of each radioisotope type 534-1 through 534-N. The activity quantities 726-1 through 726-N may, therefore, quantify an amount of each radioisotope type 534-1 through 534-N within the subject 109 of the spectrum 112.

The ML module 120 may be trained by an ML training engine 422, as disclosed herein. FIG. 7B illustrates an example 701 of a training dataset 410 configured for training of the ANN 420 illustrated in FIG. 7A. Entries 411 of the training dataset 410 may comprise spectra 112 labeled with GT values 514. The GT values 514 may comprise actual activity quantities 736 for respective radioisotope types 534 as opposed to indicating whether the training spectrum data 412 corresponds to specified emission levels 536 of the radioisotope types 534. The ML training engine 422 may be configured to train the ANN 420 to replicate the GT values 514 of the training dataset 410, as disclosed herein.

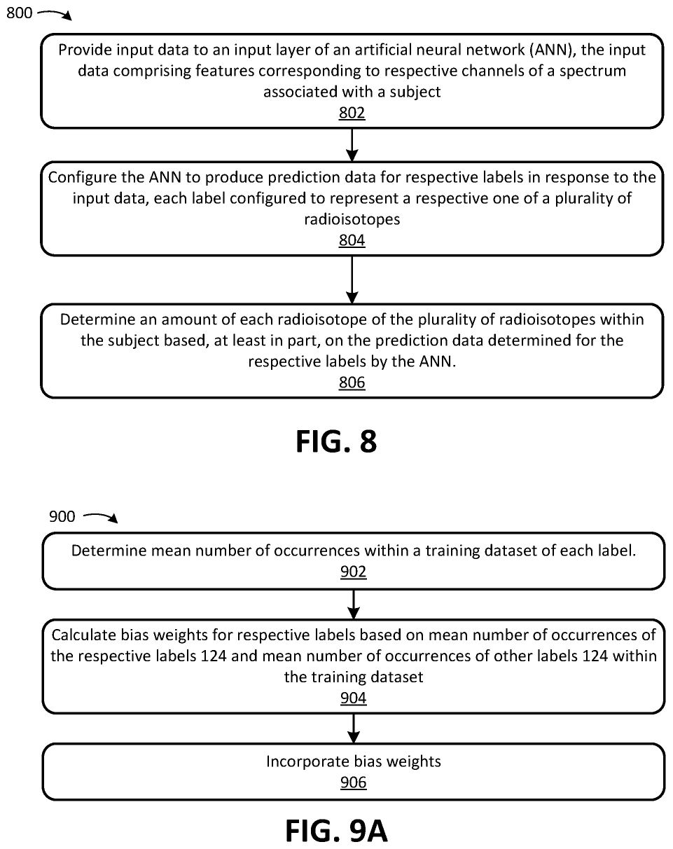

Example methods are described in this section with reference to the flow charts and flow diagrams of FIGS. 8 through 10. These descriptions reference components, entities, and other aspects depicted in FIGS. 1 through 6B by way of example only. FIG. 8 illustrates with a flow diagram an example of a method 800 for ML spectrum analysis. The flow diagram illustrating method 800 includes blocks 802 through 806. In some implementations, a device 101 can perform the operations of the method 800 (and operations of the other method flow diagrams illustrated herein). Alternatively, one or more of the operations may be performed by components of the device 101, such as processing resources 103, memory resources 104, and/or the like. Step 802 may comprise providing input data to an input layer 522 of an ANN 420 (and/or ML module 120). The input data may comprise features 144 corresponding to respective channels of a spectrum 112 associated with a subject 109, as disclosed herein. Step 804 may comprise configuring the ANN 420 to produce prediction data 126 for respective labels 124 in response to the input data, each label 124 configured to represent a respective one of a plurality of radioisotopes. Step 806 may comprise determining an amount of each radioisotope of the plurality of radioisotopes within the subject 109 based, at least in part, on the prediction data 126 determined for the respective labels 124 by the ANN 420.

Training the ANN 420 may comprise evaluating a loss function configured to quantify an error between prediction data 126 generated by the ANN 420 in response to a training spectrum 112 and a ground truth 514 of the training spectrum 112. The loss function may comprise a combination of a sigmoid layer and binary cross entropy between the prediction data 126 and the ground truth 514.

The ANN 420 may comprise ML configuration data 425 learned in a training process, as disclosed herein. In some implementations, the ANN 420 may be instantiated within the memory of a computing device. Alternatively, the ANN 420 may be implemented in circuitry, such as logic circuitry, an ASIC, FPGA, or the like. The ML configuration data 425 may be embodied and/or encoded within the hardware implementation of the ANN 420.

In some embodiments, each label 124 corresponds to a characteristic energy of the radioisotope represented by the label 124. The method 800 may further comprise configuring the ANN 420 to determine an activity quantity 726 for each label 124, the activity quantity 726 determined for each label 124 configured to quantify emission of radiation at the characteristic energy corresponding to the label 124 within the spectrum 112.

The ANN 420 may be configured to predict a plurality of labels 124, each label 124 configured to represent a respective radioisotope of the plurality of radioisotopes (a respective radioisotope type 534). The method 800 may further comprise determining the amount of each radioisotope within the subject 109 based, at least in part, on activity quantities 726 determined for each label 124 of the plurality of labels 124.

In some implementations, the ANN 420 may be configured to determine prediction data for respective labels 124, which may include a first label 124-1 configured to represent a first emission range 536-1 of a first radioisotope type 534-1 and a second label 124-2 configured to represent a second emission level 536-2 of the first radioisotope type 534-1, the second emission level 536-2 different from the first emission range 536-1. The method 800 may further comprise determining an amount of the first radioisotope 536-1 within the subject 109 based, at least in part, on first prediction data 126-1 determined for the first label 124-1 and second prediction data 126-2 determined for the second label 124-2.

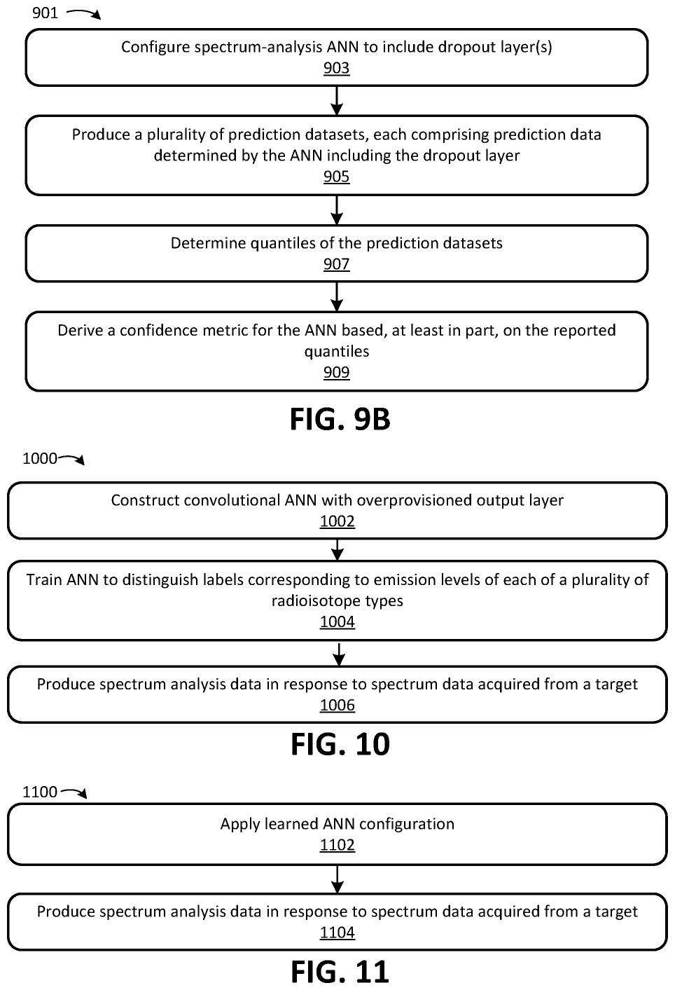

In some implementations, the ANN 420 may be configured to incorporate bias weights, the bias weights based on a determined training bias of the ANN 420. FIG. 9A illustrates an example of a method 900 for determining training bias weights. Step 902 may comprise determining a mean number of occurrences within a training dataset 410 of each label 124 of the plurality of labels 124. Step 904 may comprise calculating bias weights for respective labels 124. The bias weight of a particular label 124 may be based, at least in part, on a mean number of occurrences of the particular label 124 within the training dataset 410 and a mean number of occurrences of other labels 124 of the plurality of labels within the training dataset. Step 906 may comprise incorporating the bias weights into respective nodes 540 of the ANN 420. The method 900 may correspond to the following pseudocode:

| | |
|---|---|
| • | First, find the mean number of each of the labels out of the 32 possible |
| | isotopes we trained for; divide by 32, e.g.: weights = torch.as_tensor |
| | ([1 /np.mean(labels[i_train][:, j]) / 32 for j in range(32)], dtype= |
| | torch.float32, device=torch.device(‘cuda’)) where i_train is the |
| | dataloader frame (or training dataset 410); |
| • | Second, for each epoch, evaluate the model, y = model(x), compute the |
| | loss, where loss = loss_fn(ŷ, y), and then scale the loss by the adjusted |
| | weight, as followsloss = (loss * weights).mean( ) |
| • | Third, proceed with stochastic gradient descent, e.g. loss.backward( ), |
| | optimizer.step( ), and so on. |

In some implementations, the ML module 110 may be further configured to determine a confidence metric for the prediction data 126 determined for respective spectra 112. FIG. 9B is a flow diagram illustrating an example of a method 901 for determining a confidence metric for the prediction data 126 determined for a spectrum 112. Step 903 may comprise configuring the ANN 420 to include a dropout layer. Step 905 may comprise producing a plurality of prediction datasets (prediction data 126), each comprising prediction data 126 determined by the ANN 420 including the dropout layer. Step 907 may comprise determining quantiles for the prediction datasets. The quantiles may be configured to quantify uncertainty introduced by the dropout layer (as opposed to uncertainty in the prediction data 126 produced by the ANN 420 without dropout). The quantiles may be determined using numpy (np) or a similar technique. Step 909 may comprise deriving a confidence metric for the ANN based, at least in part, on the quantiles determined at 907. In some implementations, the method 901 may comprise implementing a number of inference iterations, e.g., n iterations of steps 905 through 907 and/or 909, as illustrated by the following pseudocode, where the lower and upper quantities represent lower and upper bounds of a confidence metric (e.g., error bars):

| | |
|---|---|
| • | n_iter = 20 |
| • | predictions = np.zeros((n_iter, y_test.shape[0], y_test.shape[1])) |
| • | for i in range(n_iter): |
| | predictions [i] = model.predict(x_test) |
| • | ○ ci = 0.90 # 90% confidence interval |
| • | lower = np.quantile(predictions, 0.5 − ci / 2, axis=0) |
| • | upper = np.quantile(predictions, 0.5 + ci / 2, axis=0) |

FIG. 10 is a flow diagram illustrating another example of a method 1000 for ML spectrum analysis. At 1002, an ML processor constructs an ANN 420 having an input layer 522, one or more convolutional layers 524, one or more dense layers 526, and an output layer 528. The convolutional layers 524 and dense layers 526 may be configured with respective dropout probabilities, such that the resulting ANN 420 is non-fully connected (in contrast to the CNN used in image processing applications). The ML module 120 is further configured to overprovision the output layer 528 of the ANN 420 by, inter alia, including more nodes 540 within the output layer 528 than unique radioisotope types 534 the ANN 420 is configured to distinguish. The ML module 120 may configure the output layer 528 to include N nodes 540. In other implementations, the ANN 420 can be configured to detect different numbers of emission levels for respective radioisotope types 534. Alternatively, the ANN 420 may be configured to determine activity quantities for each radioisotope type, as disclosed herein.

At 1004, an ML training engine 422 trains the ANN 420 to produce accurate spectrum analysis data 122 in response to entries 411 of a training dataset 410, each entry 411 including respective training spectrum data 412 and corresponding training metadata 414. The training metadata 414 may include a plurality of GT values 514, each indicating whether the training spectrum data 412 corresponds to a respective emission level 536 of a specified radioisotope type 534 (and/or respective label 124 of a vocabulary 530 the ANN 420 is being trained to distinguish). The training may include determining error metrics 553 that quantify error, differences, and/or distances between training metadata 414 of respective entries 411 and spectrum analysis data 122 produced by the ANN 420 in response to training spectrum data 412 of the entries 411. The ML training engine 422 can utilize the error metrics 553 to learn an ML configuration 425 for the ANN 420 that produces accurate spectrum analysis data 122 in response to the training dataset 410, as disclosed herein.

At 1006, the ML module 110 produces spectrum analysis data 122 in response to spectrum data 112 acquired from a subject 109. The spectrum analysis data 122 may include a plurality of predictions 126, each quantifying a probability that the subject 109 includes a specified radioisotope type 534 of a plurality of radioisotope types 534 emitting at a designated emission level 536 of a plurality of emission levels 536 of the specified radioisotope type 534.

FIG. 11 illustrates with a flow diagram 1100 example methods for an apparatus to implement ML spectrum analysis. At 1102 an ML module 110 applies a learned ML configuration 425, which may include: instantiating an ANN 420 and configuring weights, biases, and/or other parameters of layers 520, nodes 540, and/or edges of the ANN 420 in accordance with the ML configuration 425. The ML configuration 425 may be retrieved from memory resources 104, NT storage resources 105, through the data interface 107, and/or the like. The ML configuration 425 may have been learned in one or more training processes, as disclosed herein. In some implementations, the ML configuration 425 is applied within hardware components, such as an ASIC, FPGA, and/or the like. The ANN 420 may be instantiated in hardware and the ML configuration 425 may determine a configuration of the hardware-implemented ANN 420. Alternatively, or in addition, the ML configuration 425 may be applied in software components, such as an ANN instantiated in memory resources 104 and executed by processing resources 103 of the device 101. At 1104, the ML spectrum analyzer 111 produces spectrum analysis data 122 in response to spectrum data 112 acquired from a subject 109 by use of the ANN 420, as disclosed herein.

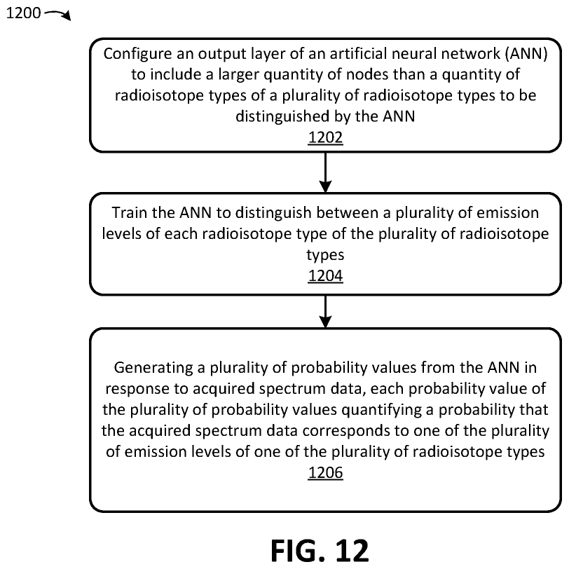

FIG. 12 illustrates with a flow diagram 1200 further example methods for an apparatus to implement ML spectrum analysis. At 1202, a ML module 120 configures an output layer of an ANN 420 to include an output layer 528 that comprises a larger quantity of nodes 540 than a quantity of radioisotope types 534 of a plurality of radioisotope types to be distinguished by the ANN 420. At 1204, an ML training engine 422 trains the ANN 420 to distinguish between a plurality of emission levels 536 of each radioisotope type 534 of the plurality of radioisotope types 534. At 1206, the ML module 120 generates a plurality of predictions 126 from the ANN 420 in response to acquired spectrum data 112 (e.g., generates spectrum analysis data 112), each quantifying a probability that the acquired spectrum data 112 corresponds to one of the plurality of emission levels 536 of one of the plurality of radioisotope types 534.

This disclosure has been made with reference to various exemplary embodiments. However, those skilled in the art will recognize that changes and modifications may be made to the exemplary embodiments without departing from the scope of the present disclosure. For example, various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

Additionally, as will be appreciated by one of ordinary skill in the art, principles of the present disclosure may be reflected in a computer program product on a computer-readable storage medium having computer-readable program code means embodied in the storage medium. Any tangible, non-transitory computer-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general-purpose computer, special purpose computer, or other programmable data processing apparatus to produce a machine, such that the instructions that execute on the computer or other programmable data processing apparatus create means for implementing the functions specified. These computer program instructions may also be stored in a computer-readable memory that can direct a computer or other programmable data processing apparatus to function in a particular manner, such that the instructions stored in the computer-readable memory produce an article of manufacture, including implementing means that implement the function specified. The computer program instructions may also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

While the principles of this disclosure have been shown in various embodiments, many modifications of structure, arrangements, proportions, elements, materials, and components, which are particularly adapted for a specific environment and operating requirements, may be used without departing from the principles and scope of this disclosure. These and other changes or modifications are intended to be included within the scope of the present disclosure.

The foregoing specification has been described with reference to various embodiments. However, one of ordinary skill in the art will appreciate that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

Those having skill in the art will appreciate that many changes may be made to the details of the above-described embodiments without departing from the underlying principles of the invention. The scope of the present invention should, therefore, be determined only by the claims.

We claim:

1. A method, comprising:
providing input data to an input layer of an artificial neural network (ANN), the input data comprising features corresponding to respective channels of a spectrum associated with a subject;
configuring the ANN to produce prediction data for respective labels in response to the input data, each label configured to represent a respective one of a plurality of radioisotopes; and
determining an amount of each radioisotope of the plurality of radioisotopes within the subject based, at least in part, on the prediction data determined for the respective labels by the ANN.

2. The method of claim 1, wherein each label corresponds to a characteristic energy of the radioisotope represented by the label, the method further comprising:
configuring the ANN to determine an activity quantity for each label, the activity quantity determined for each label configured to quantify emission of radiation at the characteristic energy corresponding to the label within the spectrum.

3. The method of claim 2, wherein the ANN is configured to predict a plurality of labels, each label configured to represent a respective radioisotope of the plurality of radioisotopes, the method further comprising:
determining the amount of each radioisotope within the subject based, at least in part, on activity quantities determined for each label of the plurality of labels.

4. The method of claim 1, wherein the ANN is configured to determine prediction data for respective labels of a plurality of labels, the plurality of labels comprising:
a first label configured to represent a first emission range of a first radioisotope of the plurality of radioisotopes; and
a second label configured to represent a second emission range of the first radioisotope, the second emission range different from the first emission range.

5. The method of claim 4, further comprising, determining an amount of the first radioisotope within the subject based, at least in part, on first prediction data determined for the first label and second prediction data determined for the second label.

6. The method of claim 1, configuring nodes of the ANN to incorporate bias weights, the bias weights based on a determined training bias of the ANN.

7. The method of claim 6, wherein the ANN is trained to predict a plurality of labels, each label configured to represent a different radioisotope of the plurality of radioisotopes, the method further comprising:
determining a mean number of occurrences within a training dataset of each label of the plurality of labels; and
calculating bias weights for respective labels of the plurality of labels, wherein the bias weight of a particular label is based, at least in part, on a mean number of occurrences of the particular label within the training dataset and a mean number of occurrences of other labels of the plurality of labels within the training dataset.

8. The method of claim 6, wherein training the ANN comprises evaluating a loss function configured to quantify an error between prediction data generated by the ANN in response to a training spectrum and a ground truth of the training spectrum, the loss function is configured to incorporate the bias weights.

9. The method of claim 8, wherein the loss function comprises a combination of a sigmoid layer and binary cross entropy between the prediction data and the ground truth.

10. The method of claim 1, further comprising determining a confidence metric for the prediction data, comprising:
configuring the ANN to include a dropout layer;
producing a plurality of prediction datasets, each prediction dataset comprising prediction data determined by the ANN including the dropout layer; and
determining quantiles of the prediction datasets.

11. An apparatus, comprising:
a processor; and
a machine-learned (ML) module configured for operation on the processor, the ML module comprising an artificial neural network (ANN) comprising an input layer, a first hidden layer, and an output layer;
wherein the ANN is trained to produce prediction data for respective labels in response to radiation spectra, the labels configured to represent respective radioisotopes of a plurality of radioisotopes, and
wherein the prediction data produced by the ANN in response to a spectrum of a subject is configured to predict an amount of each radioisotope of the plurality of radioisotopes within the subject.

12. The apparatus of claim 11, wherein the first hidden layer of the ANN comprises a larger number of nodes than the input layer of the ANN.

13. The apparatus of claim 11, wherein nodes of the ANN are configured to implement hyperbolic tangent activation functions.

14. The apparatus of claim 11, wherein nodes of the ANN comprise bias weights, the bias weights based on a mean of occurrences of respective labels within a training dataset.

15. A non-transitory computer-readable storage medium comprising instructions configured to cause a processor of a computing device to implement operations, comprising:
providing input data to an input layer of an artificial neural network (ANN), the input data comprising features corresponding to respective channels of a spectrum associated with a subject;
configuring the ANN to produce prediction data for respective labels in response to the input data, each label configured to represent a respective one of a plurality of radioisotopes; and
determining an amount of each radioisotope of the plurality of radioisotopes within the subject based, at least in part, on the prediction data determined for the respective labels by the ANN.

16. The non-transitory computer-readable storage medium of claim 15, wherein each label corresponds to a characteristic energy of the radioisotope represented by the label, the operations further comprising:
configuring the ANN to determine an activity quantity for each label, the activity quantity determined for each label configured to quantify emission of radiation at the characteristic energy corresponding to the label within the spectrum.

17. The non-transitory computer-readable storage medium of claim 16, wherein the ANN is configured to predict a plurality of labels, each label configured to represent a respective radioisotope of the plurality of radioisotopes, the operations further comprising:
determining the amount of each radioisotope within the subject based, at least in part, on activity quantities determined for each label of the plurality of labels.

18. The non-transitory computer-readable storage medium of claim 15, wherein the ANN is configured to determine prediction data for respective labels of a plurality of labels, the plurality of labels comprising:
a first label configured to represent a first emission level of a first radioisotope of the plurality of radioisotopes; and
a second label configured to represent a second emission level of the first radioisotope, the second emission level different from the first emission level.

19. The non-transitory computer-readable storage medium of claim 18, further comprising, determining an amount of the first radioisotope within the subject based, at least in part, on first prediction data determined for the first label and second prediction data determined for the second label.

20. The non-transitory computer-readable storage medium of claim 15, configuring nodes of the ANN to incorporate bias weights, the bias weights based on a determined training bias of the ANN.

21. The non-transitory computer-readable storage medium of claim 20, wherein the ANN is trained to predict a plurality of labels, each label configured to represent a different radioisotope of the plurality of radioisotopes, the operations further comprising:
determining a mean number of occurrences within a training dataset of each label of the plurality of labels; and
calculating bias weights for respective labels of the plurality of labels, wherein the bias weight of a particular label is based, at least in part, on a mean number of occurrences of the particular label within the training dataset and a mean number of occurrences of other labels of the plurality of labels within the training dataset.

22. The non-transitory computer-readable storage medium of claim 20, wherein training the ANN comprises evaluating a loss function configured to quantify an error between prediction data generated by the ANN in response to a training spectrum and a ground truth of the training spectrum, the loss function is configured to incorporate the bias weights.

23. The non-transitory computer-readable storage medium of claim 22, wherein the loss function comprises a combination of a sigmoid layer and binary cross entropy between the prediction data and the ground truth.

24. The non-transitory computer-readable storage medium of claim 15, further comprising determining a confidence metric for the prediction data, comprising:
configuring the ANN to include a dropout layer;
producing a plurality of prediction datasets, each prediction dataset comprising prediction data determined by the ANN including the dropout layer; and
determining quantiles of the prediction datasets.
